(19) United States
(12) Patent Application Publication
(10) Pub. No.: US 2018/0095674 A1
(43) Pub. Date: Apr. 5, 2018

(54) SELECTIVE DATA COMPRESSION/DECOMPRESSION FOR INTERMEMORY TRANSFER INTERFACE

(71) Applicant: INTEL CORPORATION, Santa Clara, CA (US)

(72) Inventors: Alaa R. ALAMELDEEN, Hillsboro, OR (US); Glenn J. HINTON, Portland, OR (US); Blaise FANNING, Folsom, CA (US); Robert J. ROYER, JR., Portland, OR (US); James J. GREENSKY, Portland, OR (US)

(21) Appl. No.: 15/283,124

(22) Filed: Sep. 30, 2016

(51) Int. Cl. G06F 3/06

(52) U.S. Cl. CPC G06F 3/0611; G06F 3/0673; G06F 3/0646

(57) ABSTRACT

In one embodiment, an inter-memory transfer interface having selective data compression/decompression in accordance with the present description, selects from multiple candidate processes, a compression/decompression process to compress a region of data from a near memory before transmitting the compressed data to the far memory. In another aspect, the inter-memory transfer interface stores metadata indicating the particular compression/decompression process selected to compress that region of data. The stored metadata may then be used to identify the compression/decompression technique selected to compress a particular region of data, for purposes of locating the compressed data and subsequently decompressing data of that region when read from the far memory. Other aspects are described herein.

### TECHNICAL FIELD

Certain embodiments of the present description relate generally to management of memory resources.

### BACKGROUND

A memory capable of storing a large amount of data frequently has drawbacks such as slower input/output speeds as compared to smaller capacity memories. Conversely, smaller memories which may be faster to operate, may have a greater cost to store data on a per bit basis, as compared to larger capacity memories. Accordingly, computer systems frequently employ a two-level memory system, often referred to as a “heterogeneous” memory system employing a smaller, faster memory as a cache memory for a second, larger and frequently slower memory.

The smaller cache memory is often positioned closer to the central processing unit and thus may have a relatively short data path to the central processing unit to facilitate faster read and write operations between the central processing unit and the cache. Hence, the cache memory is often referred to as the “near” memory. Conversely, the larger, second memory is often positioned more distant from the central processing unit. As a result, the larger, second memory typically has a longer data path to the central processing unit and is frequently referred to as the “far” memory.

Because read and write operations may often be performed more quickly for data stored in the near memory, selected data initially stored in the far memory may be read from the far memory and temporarily cached in the near memory if it is anticipated that the data will be frequently accessed. If the data is modified in the near memory, it may be transferred back to the far memory for storage.

Due to technology differences between read and write operations, read data being transferred in a read operation from a far memory to a near memory may be transferred in relatively small units of data such as a sector of data, for example, to reduce latency of such read operations. Conversely, write operations transferring write data from the near memory to the far memory may be transferred in relatively large units of data which may include many sectors of data to reduce the overhead often associated with such write operations.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating one embodiment of a system employing an inter-memory transfer interface having selective data compression/decompression in accordance with the present description.

FIGS. 2a-2d depict various hierarchical levels of data storage of the memory of FIG. 1.

FIG. 3 depicts an embodiment of an input/output controller employing selective data compression/decompression for an inter-memory transfer interface in accordance with the present description.

FIGS. 4a, 4b depict an embodiment of operations of an inter-memory transfer interface employing selective data compression/decompression in accordance with the present description.

FIG. 5 depicts another embodiment of an inter-memory transfer interface employing selective data compression/decompression in accordance with the present description.

FIG. 6 depicts one example of region of data stored in a near memory of an inter-memory transfer interface employing selective data compression/decompression in accordance with the present description.

FIGS. 7a-7c depict various examples of data structures storing metadata for regions of data stored in a near memory of an inter-memory transfer interface employing selective data compression/decompression in accordance with the present description.

FIGS. 8a-8g depict various embodiments of compression/decompression processes for an inter-memory transfer interface employing selective data compression/decompression in accordance with the present description.

### DESCRIPTION OF EMBODIMENTS

In the description that follows, like components have been given the same reference numerals, regardless of whether they are shown in different embodiments. To illustrate one or more embodiments of the present disclosure in a clear and concise manner, the drawings may not necessarily be to scale and certain features may be shown in somewhat schematic form. Features that are described or illustrated with respect to one embodiment may be used in the same way or in a similar way in one or more other embodiments or in combination with or instead of features of other embodiments.

It is appreciated that in a data path between a near memory and a far memory, the bandwidth or data carrying capabilities of the data path may be limited for various reasons. As a result, such a bandwidth limitation may incur significant slowing in system operations during intervals of high demand on the far memory. Moreover, data traffic between the near and far memory may increase power consumption of the system.

To increase effective data transfer rates and reduce power consumption, an inter-memory transfer interface in accordance with one aspect of the present description employs selective data compression of one or more compression/decompression processes before transmitting data from the near memory to the far memory. It is appreciated that depending upon the pattern of data within a region, one compression/decompression process may be more optimal than another compression/decompression process, to increase an effective data transfer rate for that region of data.

Accordingly, an inter-memory transfer interface in accordance with one aspect of the present description, selects from multiple candidate compression/decompresses processes, a more optimal compression/decompression process to compress a region of data from the near memory before transmitting the compressed data to the far memory. In another aspect, the inter-memory transfer interface stores metadata indicating the particular compression/decompression process selected to compress that region of data. The stored metadata may then be used to identify the compression/decompression technique selected to compress a particular region of data, for purposes of subsequently decompressing data of that region when read from the far memory.

It is further appreciated that a region of memory storing multiple blocks of sectors of data may be compressed into a different number of blocks of sectors of compressed data, depending upon the particular compression/decompression technique or process selected to compress the data. As a result, the location of a sector of data targeted for a read operation within the compressed data may change as a function of the compression/decompression process selected to compress the data. Accordingly, to read and decompress the targeted sector of data, the sector of compressed data stored in the far memory containing the targeted sector is identified as a function of the metadata stored for the targeted sector, and is read from the far memory. Furthermore, the identified sector of compressed data read from the far memory, is decompressed as a function of the metadata identifying the compression/decompression process selected for the targeted sector, to restore the targeted sector.

In another aspect of an inter-memory transfer interface in accordance with the present description, a sector of data when compressed for transfer and storage in the far memory, may be completely enclosed within a similar sized sector of compressed data which is then transferred and stored in the far memory. Thus, in one embodiment, a particular sector of data when compressed does not extend beyond the boundaries of a single sector of compressed data. Such encapsulation of one or more sectors within the boundaries of a compressed sector can further increase system performance.

An inter-memory transfer interface in accordance with the present description is described herein in connection with sectors of data, blocks of sectors and regions of blocks. However, it is appreciated that an inter-memory transfer interface in accordance with the present description may be applied to other units and subunits of data such as volumes, tracks, segments, files, etc.

An inter-memory transfer interface having selective data compression/decompression in accordance with the present description may, in one embodiment, be employed in a system of one or more computers configured to perform particular operations or actions of the inter-memory transfer interface, by virtue of having software, firmware, hardware, or a combination of them installed on the system that in operation causes or cause the system to perform the actions. One or more computer programs can be configured to perform particular operations or actions of an inter-memory transfer interface having selective data compression/decompression, by virtue of including instructions that, when executed by data processing apparatus, cause the apparatus to perform the actions.

Other embodiments include corresponding computer systems, apparatus, and computer programs recorded on one or more computer storage devices, each configured to perform the actions of the methods. Implementations of the described techniques may include hardware, a method or process, or computer software on a computer-accessible medium.

It is appreciated that an inter-memory transfer interface employing selective data compression/decompression in accordance with the present description may be applied to a variety of host, storage and other memory devices such as for example, magnetic, solid state and optical disk drives, and solid state memory devices that use chalcogenide phase change material (e.g., chalcogenide glass), three-dimensional (3D) crosspoint memory, or memory that incorporates memristor technology. Additional memory devices which may benefit from an inter-memory transfer interface having selective data compression/decompression in accordance with the present description may include other types of byte-addressable, write-in-place non-volatile memory, ferroelectric transistor random-access memory (FeTRAM), nanowire-based non-volatile memory, Magnetoresistive random-access memory (MRAM), Spin Transfer Torque (STT)-MRAM, Phase Change Memory (PCM), storage class memory (SCM), universal memory, Ge2Sb2Te5, programmable metallization cell (PMC), resistive memory (RRAM), RESET (amorphous) cell, SET (crystalline) cell, PCME, Ovshinsky memory, ferroelectric memory (also known as polymer memory and poly(N-vinylcarbazole)), ferromagnetic memory (also known as Spintronics, SPRAM (spin-transfer torque RAM)), STRAM (spin tunneling RAM), magnetic memory, magnetic random access memory (MRAM), and Semiconductor-oxide-nitride-oxidesemiconductor (SONOS, also known as dielectric memory). It is appreciated that other types of memory may benefit from an inter-memory transfer interface having selective data compression/decompression in accordance with the present description, depending upon the particular application. Turning to the figures, FIG. 1 is a high-level block diagram illustrating selected aspects of a computing system implemented according to an embodiment of the present disclosure. System 10 may represent any of a number of electronic or other computing devices, that may include a memory device. Such electronic devices may include a cloud storage system and other computing devices such as a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.) or component (e.g. system on a chip, processor, bridge, memory controller, memory, etc.). System 10 can be powered by a battery, renewable power source (e.g., solar panel), wireless charging, or by use of an AC outlet.

In alternative embodiments, system 10 may include more elements, fewer elements, and/or different elements. Moreover, although system 10 may be depicted as comprising separate elements, it will be appreciated that such elements may be integrated on to one platform, such as systems on a chip (SoCs). In the illustrative example, system 10 comprises a central processing unit or microprocessor 20, a memory controller 30, a memory 40, an offload data transfer engine 44, and peripheral components 50 which may include, for example, video controller, input device, output device, storage, network adapter, a power source (including a battery, renewable power source (e.g., photovoltaic panel), wireless charging, or coupling to an AC outlet), etc. The microprocessor 20 includes a cache 25 that may be part of a memory hierarchy to store instructions and data, and the system memory 40 may also be part of the memory hierarchy. The microprocessor 20 further includes logic 27 which may include one or more cores, for example. Communication between the microprocessor 20 and the memory 40 may be facilitated by the memory controller (or chipset) 30, which may also facilitate in communicating with the peripheral components 50.

Peripheral components 50 which are storage devices may be, for example, non-volatile storage, such as solid-state drives (SSD), magnetic disk drives including redundant arrays of independent disks (RAID), optical disk drives, a tape drive, flash memory, etc. The storage may comprise an internal storage device or an attached or network accessible storage. The microprocessor 20 is configured to write data in and read data from the memory 40. Programs in the storage are loaded into the memory and executed by the processor. The offload data transfer engine 44 facilitates memory to memory data transfers which bypass the microprocessor to lessen the load of such transfers on the microprocessor 20. As explained in greater detail below, one embodiment of an inter-memory transfer interface having selective data compression/decompression in accordance with the present description, can reduce traffic between a near memory and a far memory to improve system performance.

A network controller or adapter enables communication with a network, such as an Ethernet, a Fiber Channel Arbitrated Loop, etc. Further, the architecture may, in certain embodiments, include a video controller configured to display information represented by data in a memory on a display monitor, where the video controller may be embodied on a video card or integrated on integrated circuit components mounted on a motherboard or other substrate. An input device is used to provide user input to the processor, and may include a keyboard, mouse, pen-stylus, microphone, touch sensitive display screen, input pins, sockets, or any other activation or input mechanism known in the art. An output device is capable of rendering information transmitted from the processor, or other component, such as a display monitor, printer, storage, output pins, sockets, etc. The network adapter may embodied on a network card, such as a Peripheral Component Interconnect (PCI) card, PCI-express, or some other I/O card, or on integrated circuit components mounted on a motherboard or other substrate. The peripheral devices 50 may also include RF receiver/transmitters such as in a mobile telephone embodiment, for example. Additional examples of peripheral devices 50 which may be provided in the system include an audio device and temperature sensor to deliver temperature updates for storage in the memory.

One or more of the components of the device 10 may be omitted, depending upon the particular application. For example, a network router may lack a video controller, for example.

Any one or more of the memory devices 25, 40, and the other devices 10, 30, 50 may include a memory employing an inter-memory transfer interface having selective data compression/decompression in accordance with the present description, or be embodied as any type of data storage capable of storing data in a persistent manner (even if power is interrupted to non-volatile memory) such as but not limited to any combination of memory devices that use for example, chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM) or another Spin Transfer Torque (STT)-MRAM as described above. Such memory elements in accordance with embodiments described herein can be used either in stand-alone memory circuits or logic arrays, or can be embedded in microprocessors and/or digital signal processors (DSPs). Additionally, it is noted that although systems and processes are described herein primarily with reference to microprocessor based systems in the illustrative examples, it will be appreciated that in view of the disclosure herein, certain aspects, architectures, and principles of the disclosure are equally applicable to other types of device memory and logic devices.

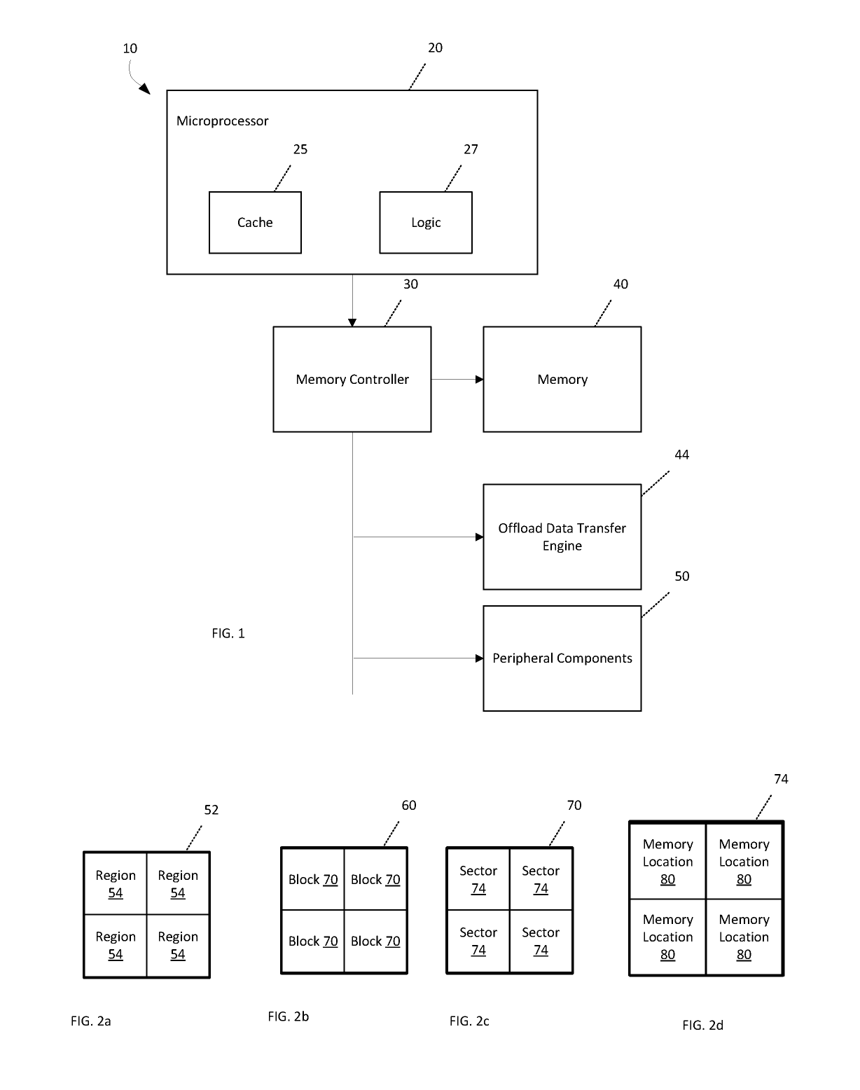

One or more of the memory 40 and storage devices of the peripheral devices 50 may have a rectangular or orthogonal array of rows and columns of cells such as bit cells in which each bit cell is configured to store a bit state. An array of bit cells may be logically subdivided in an array 52 of regions 54 (FIG. 2a). Depending upon the size of the memory, the array of bit cells may have tens, hundreds, thousands, or more of such regions 54. A region 54 may be logically subdivided in an array 60 of blocks 70 (FIG. 2b). Depending upon the size of the memory, the array of blocks may have a single block or tens, hundreds, thousands, or more of such blocks 70. In one embodiment, the memory 40 or storage device of the devices 50 may include a non-volatile memory such as a flash memory, for example, in which each block 70 represents the smallest subunit of the memory which may be erased at one time.

Each block 70 may in turn be subdivided into an array of sectors 74 (FIG. 2c). Depending upon the size of the memory, a block 70 of sectors 74 may have a single sector or tens, hundreds, thousands, or more of such sectors 74. Each sector 74 may in turn be subdivided into an array of memory locations 80 (FIG. 2d). Depending upon the size of the memory, a sector 74 of memory locations 80 may have tens, hundreds, thousands, or more of such memory locations 80. One specific example of a sector is sized sufficiently to store 512 bytes of data. Each memory location includes one or more bit cells to store a bit, a byte, a word or other subunit of data, depending upon the particular application. Although an inter-memory transfer interface in accordance with the present description is described in connection with storing data in a block of one or more sectors, it is appreciated that other units of data storage such as pages, tracks, segments, files, volumes, disks, drives, etc., may be utilized, depending upon the particular application.

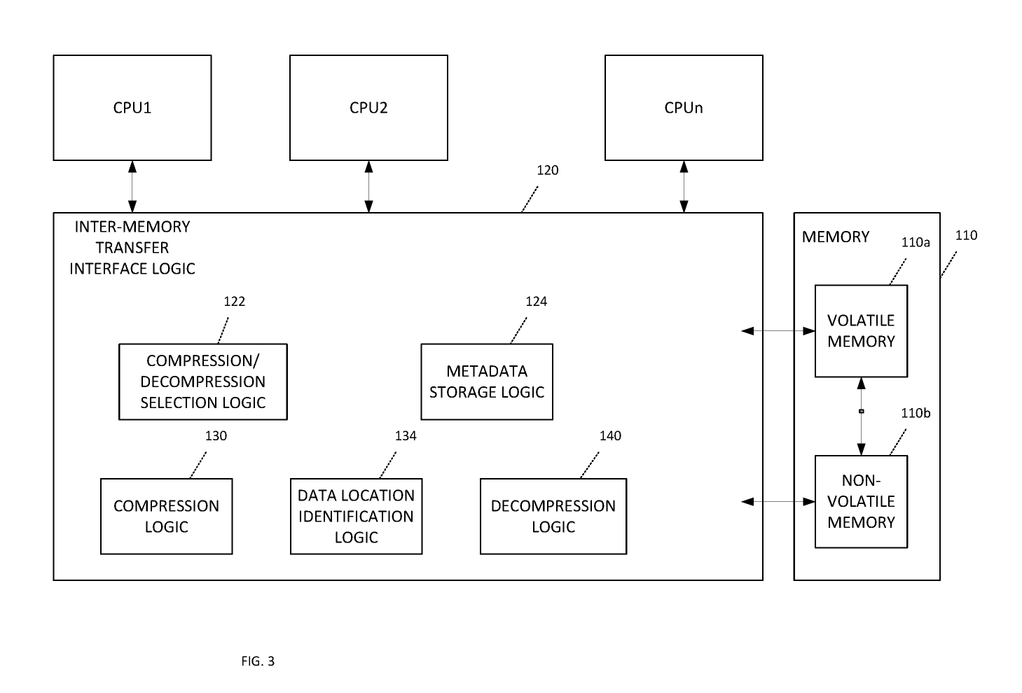

FIG. 3 is a high-level block diagram illustrating selected aspects of another embodiment of a computing system implementing an inter-memory transfer interface in accordance with the present description. In this embodiment, the computing system includes a plurality of central processing units CPU1, CPU2, . . . CPUn, each of which may include a core processor. The computing system further includes a memory subsystem 110 and an inter-memory transfer interface logic 120 between the central processing units CPU1, CPU2, . . . CPUn and the memory subsystem 110 which may include one or more memories such as a near memory 110a and a far memory 110b, for example. The inter-memory transfer interface logic 120 is configured to control input/output operations for the memory subsystem 110. For example, the inter-memory transfer interface logic 120 is configured to store in a memory region of the memory subsystem 110, a plurality of units of data, such as blocks of sectors of data or other subunits of data. It is appreciated that an inter-memory transfer interface in accordance with the present description, may utilize other units and subunits of data and other computer architectures, depending upon the particular application.

In one embodiment, the inter-memory transfer interface logic 120 includes compression/decompression selection logic 122 configured to select a compression/decompression process to process a memory region of data of the near memory 110a before the data is transmitted to and stored in the far memory 110b. A metadata storage logic 124 of the inter-memory transfer interface logic 120, is configured to store metadata to indicate a compression/decompression process selected to process a region of data for transmission to the far memory 110b. As used herein, a compression/decompression process in one example, compresses data into a compressed form, or decompresses compressed data into an uncompressed form. In another example, a selected compression/decompression process may selectively leave uncompressed data as uncompressed.

The inter-memory transfer interface logic 120 further includes compression logic 130 configured to compress a memory region of uncompressed data to one or more smaller units of compressed data using the compression/decompression process selected by the compression/decompression selection logic 122. For example, the compression logic 130 may be configured to compress a region of data in several trials, each compression/decompression trial using a different candidate compression/decompression process to provide a trial result of one or more units of compressed data, depending upon the candidate compression/decompression process. The compression/decompression selection logic 122 may be configured to compare the trial results of each compression/decompression trial for a particular region, and select the candidate compression/decompression process which provided the least number of units of compressed data, to increase effective data transfer rate and reduce power consumption.

Accordingly, the metadata storage logic 124 of the inter-memory transfer interface logic 120, is configured to store metadata in association with the memory region being processed, to identify the compression/decompression process selected for the associated memory region. The inter-memory transfer interface logic is further configured to transmit one or more units of processed data such as compressed or uncompressed data for storage in the far memory 110b.

In the illustrated embodiment, each unit or block of compressed data transmitted to the far memory 110b may include multiple subunits or sectors of compressed data, each sector of compressed data including one or more sectors of data from the near memory 110a but in compressed form. In one aspect of the present description, each sector of data from the near memory 110a which has been compressed and stored in the far memory 110b, is fully contained, that is, enclosed or encapsulated within the field of data defined by a sector of compressed data transferred to and stored in the far memory 110b. Accordingly, the compressed data representing a sector of data from the near memory 110a lies within a single sector of compressed data and does not extend to more than one sector of compressed data.

The inter-memory transfer interface logic 120 is further configured to read processed data such as compressed data from the far memory 110b and decompress it if needed, to restore the data in uncompressed form for storage in the near memory 110a. In this embodiment, the inter-memory transfer interface logic includes data location identification logic 134 configured to read the metadata stored for a memory region containing a sector which has been compressed and stored in the far memory 110b. As explained in greater detail below, the data location identification logic 134 is configured to use the read metadata, to identify the sector of compressed data stored in the far memory 110b which contains the particular sector of data to be restored, as a function of the read metadata indicating the compression/decompression process selected to compress the data of the region of the particular sector, and as a function of a subunit identification such as a sector number, of the particular sector of data to be restored.

The inter-memory transfer interface logic 120 is further configured to read the identified sector of compressed data from the far memory. A decompression logic 140 of the inter-memory transfer interface logic 120, is configured to receive and decompress the sector of data read from the far memory 110b if it has been compressed. The decompression logic 140 decompresses a sector of compressed data as a function of the read metadata indicating the compression/decompression process selected to generate the sector of compressed data. In this manner, the particular sector of data is restored from the compressed sector of data read from the far memory 110b. The inter-memory transfer interface logic is further configured to store the data in uncompressed form in the near memory 110a.

In one embodiment, the inter-memory transfer interface logic 120 may be implemented in one or more memory controllers. In another embodiment, the inter-memory transfer interface logic 120 may be implemented a direct memory access (DMA) controller or engine.

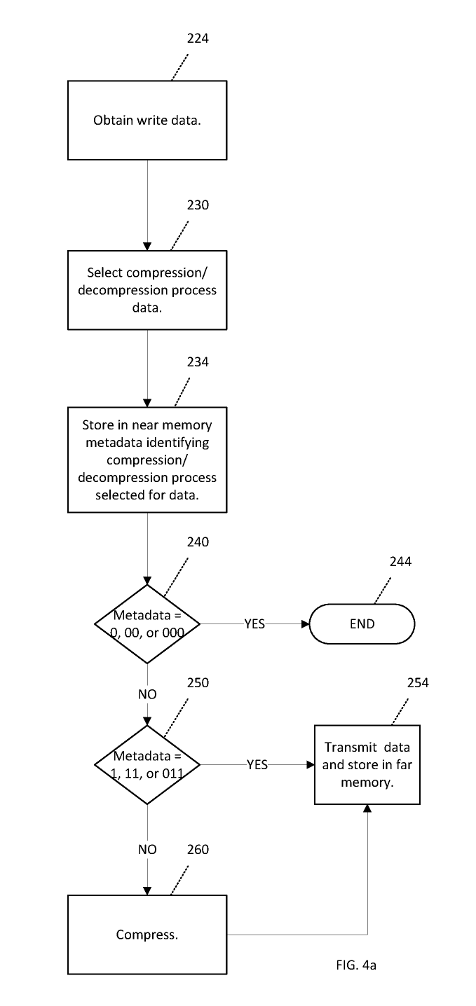

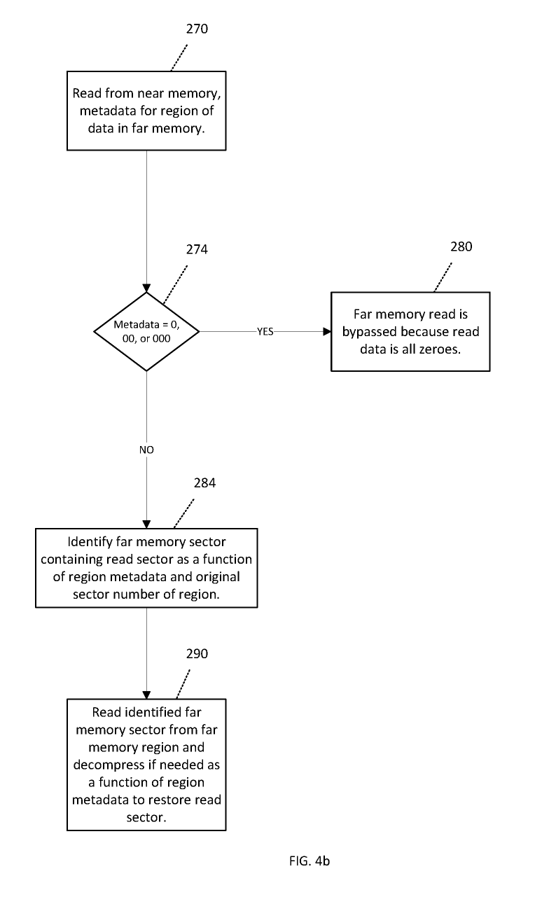

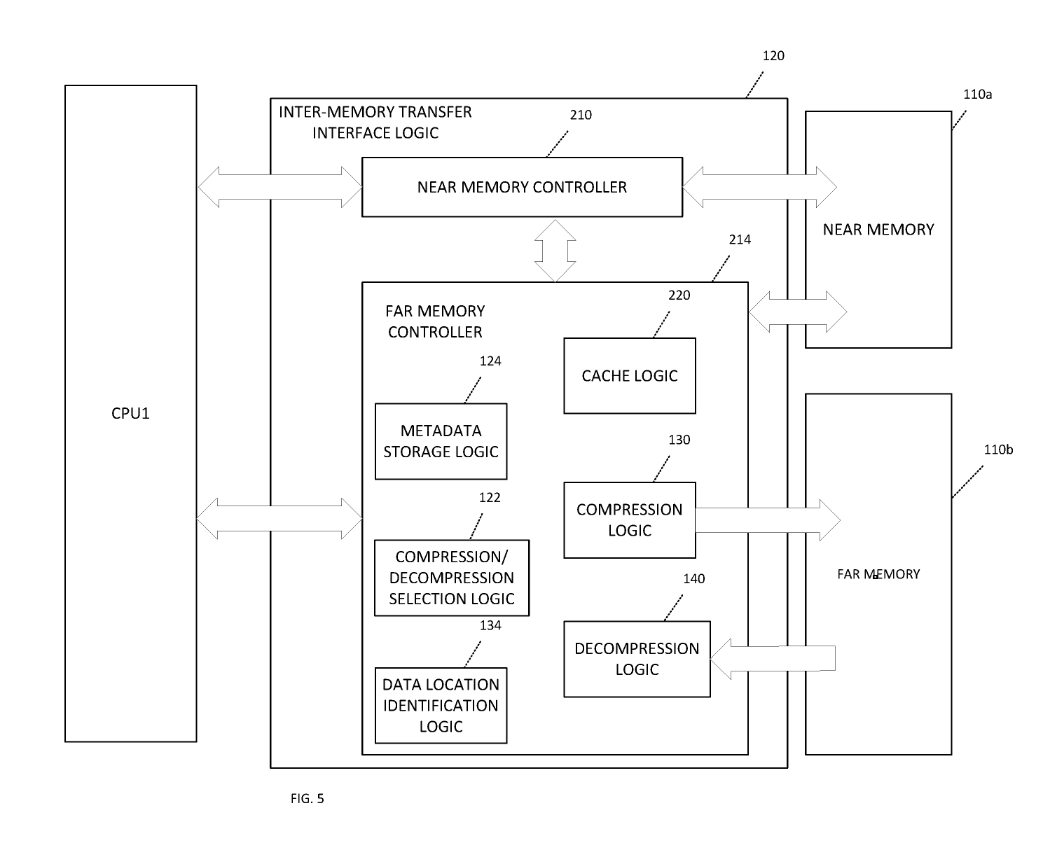

FIGS. 4a, 4b depict examples of operations of an inter-memory transfer interface employing selective data compression/decompression in accordance with the present description. FIG. 4a is directed to a write operation in which data is read from a source such as the near memory 110a (FIG. 3), and is compressed (or left unchanged) in accordance with a selected compression/decompression process and stored in the far memory 110b. FIG. 4b is directed to a read operation in which data is read from the far memory 110b (FIG. 3), and is decompressed if previously compressed in accordance with the selected compression/decompression process, to restore the data to uncompressed form, and stored in another memory such as the near memory 110a.

FIG. 5 depicts an embodiment of an inter-memory transfer interface logic 120 in accordance with the present description, which employs a near memory controller 210 for the near memory 110a, and a far memory controller 214. It is appreciated that logic elements depicted in connection with the far memory controller 214 may be located within the near memory controller 210 and vice versa, in other embodiments.

In this embodiment, a cache logic 220 of the far memory controller 214 caches data from the far memory 110b into the near memory 110a, to facilitate read operations by a central processing unit such as the central processing unit CPU1, for example. Data cached in the near memory 110a may be evicted by the cache logic 220 for various reasons such as to make room in the near memory 110a for other data deemed more likely to be accessed by a central processing unit. Data being evicted from the near memory 110a may in some embodiments, be simply discarded if the data being evicted is unchanged and is already stored in the far memory 110b. However, if the data being evicted is new data or data that has been modified, often referred to as “dirty” data, the data being evicted may be compressed and transferred to the far memory 110b as compressed write data to the far memory 110b.

Accordingly, FIG. 4a is directed to a data transfer operation in which write data being evicted from the near memory 110a (FIG. 5) is obtained (block 224, FIG. 4a) by the far memory controller 214 either directly from the near memory 110a or through the near memory controller 210 of the inter-memory transfer interface 120. Although described in connection with an eviction of data from a cache memory such as the near memory 110a, it is appreciated that an inter-memory transfer interface in accordance with the present description may be applied to other types of write operations and other types of memory.

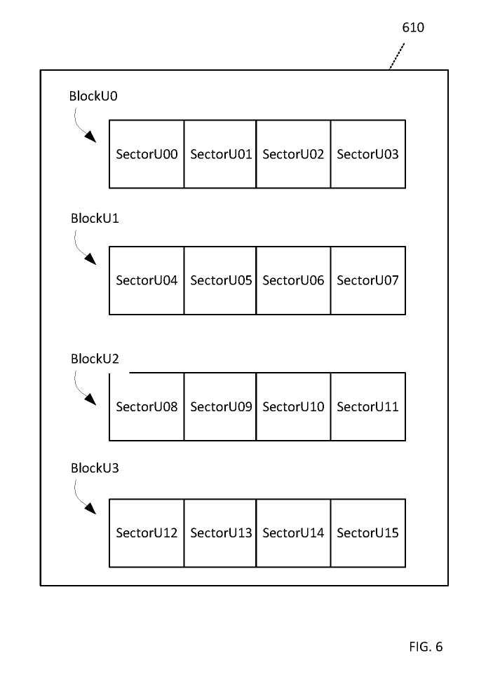

FIG. 6 shows an example of a region 610 of four KB (kilobytes) (that is, 4096 bytes) of uncompressed data which may be obtained from the near memory 110a. In this example, each region, such as region 610, contains sixteen sectors of uncompressed data, designated sectorU00, sectorU01 . . . sectorU15. Thus, each sector contains 256 bytes of uncompressed data. In this embodiment read operations from the far memory 110b are performed at a sector-sized granularity such that each read operation may retrieve one sector of data from the far memory 110b in one embodiment. It is appreciated the read operations may be conducted using other sizes of data units and subunits, depending upon the particular application.

The data of each region is further arranged in blocks, each block having four sectors of uncompressed data, that is, a kilobyte (1024 bytes) of uncompressed data. Hence, in the example of FIG. 6, the region 610 has a first blockU0 of four sectors, that is, sectorU00, sectorU01, sectorU02 and sectorU03 of uncompressed data, a second blockU1 of four sectors, that is, sectorU04-sectorU07 of uncompressed data, a third blockU2 of four sectors, that is, sectorU08-sectorU11 of uncompressed data, and a fourth blockU3 of four sectors, that is, sectorU12-sectorU15 of compressed data. In this embodiment write operations to the far memory 110b are performed at a block-sized granularity, that is, each write operation may transfer one block of data to the far memory 110b. It is appreciated that data may be arranged and transferred in other formats of other numbers and types of data units and data subunits.

The compression/decompression selection logic 122 of the far memory controller 214 selects (block 230, FIG. 4a) a compression/decompression process to process the data of the memory region 610 (FIG. 6) of the near memory 110a before the processed data is transmitted to and stored in the far memory 110b. In one embodiment, the goal for architecture of the inter-memory transfer interface logic 120 is to write the fewest possible number of blocks to the far memory 110b while retaining the capability to read the smaller sector size from the far memory 110b and into the near memory 110a. Accordingly, the compression/decompression selection logic 122 of the far memory controller 214 can select (block 230, FIG. 4a) a compression/decompression process to compress or otherwise process the data of the memory region 610 (FIG. 6) so that the fewest number of blocks after compression are needed to write the data to the far memory 110b, but will still allow a read operation to access a single 256 byte sector from the far memory 110b.

In one aspect of the present description, an inter-memory transfer interface in accordance with the present description makes available multiple, different processes as candidate compression/decompression processes from which to select, to increase the benefit from compression. In that different compression/decompresses processes may be selected to compress different regions of data, a data transfer interface in accordance with another aspect of the present description stores metadata for each such processed region of data to indicate the particular compression/decompression process used to compress or otherwise process the associated region of data. Such metadata may be stored in the near memory 110a, for example, and subsequently read for use in identifying the location of a particular sector and decompressing the targeted sector if needed, as a function of the metadata indicating how the sector was processed.

The metadata storage logic 124 of the far memory controller 214 stores (block 234, FIG. 4a) metadata to indicate the particular compression/decompression process selected to process the data of the memory region 610 for transmission to the far memory 110b. It is appreciated that the more bits of metadata stored for a region of data, the greater the number of candidate compression/decompresses processes that may be available from which to select. As a result, the greater the number of candidate compression/decompresses processes from which to select, the more likely that a suitable compression/decompression process is available to optimize the compression of various different patterns of data, to reduce data transmission traffic between the near and far memories. It is appreciated that candidate compression/decompression processes may include a process which leaves the bits unchanged (no compression) prior to transmission to the far memory.

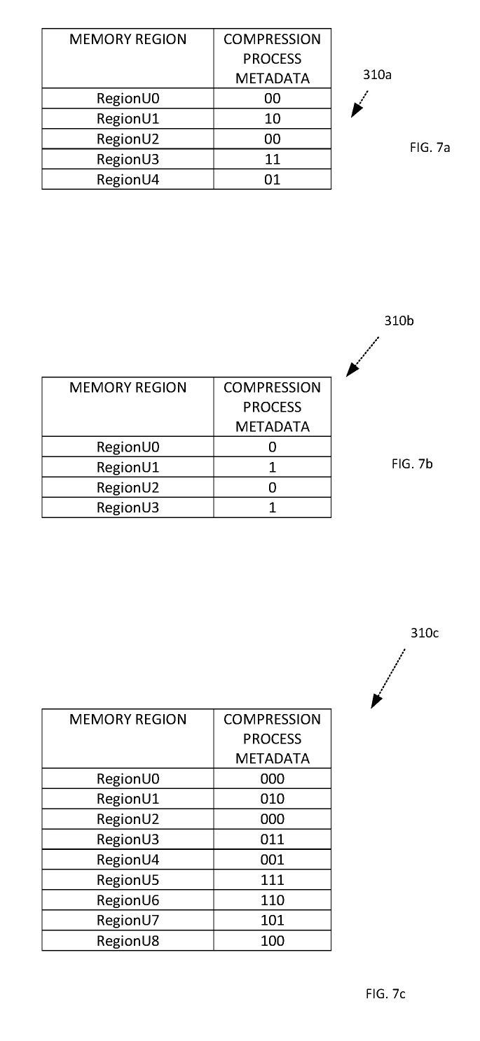

FIG. 7a shows an example of a data structure 310a which may be stored in the near memory 110a, for example. In this example, the metadata stored for each region has two bits of metadata, such that the metadata has the capacity to identify up to four different compression/decompression processes in that the metadata has four possible defined states, 00, 01, 10 and 11. It is appreciated that the number of metadata bits may vary, depending upon the particular application. For example, compression/decompression selection logic may be configured to select a compression process to compress a first region of data, wherein the metadata storage logic is further configured to store at least one bit of metadata for the first region of data to indicate a compression process selected for the first region of data wherein the metadata for the first region of data has a first defined state if the first region of data is compressed in a first compression process, and wherein the metadata for the first region of data has a second defined state if the first region of data is compressed in a second compression process. Thus, the metadata for the first region of data has an nth defined state if the first region of data is compressed in an nth compression process wherein the number of bits of metadata is greater than one if n is greater than two.

In this embodiment, the data structure 310a has an entry for each region of the near memory 110a which has been processed for transmission to the far memory 110b for storage. Each entry has a field referenced as “memory region” which identifies the associated memory region, and another field storing the metadata for the associated memory region. Thus, in this example, the metadata value 00 is stored for the associated memory region regionU0, and indicates that the memory regionU0 was processed using the selected compression/decompression process identified by the metadata value 00.

Other regions may have been processed using other selected compression/decompression processes as indicated by the values stored in the fields of the other entries of the data structure 310a as shown in FIG. 7a. It is appreciated that a data structure storing metadata for regions or other areas of data in a memory may utilize other fields in addition to or instead of those depicted herein.

FIG. 7b shows another example of a data structure 310b in which the metadata stored for each region has a single bit of metadata, such that the metadata has the capacity to identify up to two different compression/decompression processes in that the metadata has two possible states, 0, 1. In this example, a region of data is compressed only if all bits of the regions are of a single common state such as all zeroes, for example.

Conversely if some of the bits of the region are of the other state, such as a one state, the region is left uncompressed for transmission. Accordingly, the single metadata bit will indicate whether the region is all zeroes (metadata bit=zero) or is uncompressed (metadata bit=one). Thus, in this example, a metadata state equal to one indicates that the selected compression/decompression process is one in which the bits of the region are left unchanged, that is, not compressed.

In one example of a write operation depicted in FIG. 4a in connection with assignment of a single bit of metadata, a compression/decompression process is selected (block 230) by examining the region of data from which the write data was obtained (block 234) to determine if it contains all zeroes or a mixture of ones and zeroes. Thus, in the example of FIG. 7b, regionU0 is determined (block 230) to contain all zeroes and therefor a zero is stored (block 234, FIG. 4a) in the associated metadata entry of the data structure 310b (FIG. 7b). Similarly regionU2 is all zeroes in this example and therefor a zero is stored in the associated metadata as shown in FIG. 7b. Conversely, regionU1 is a mixture of ones and zeroes and there for a one is stored in the associated metadata. Similarly regionU3 is a mixture of ones and zeroes and there for a one is stored in the associated metadata.

If it is determined (block 240, FIG. 4a) that the metadata for a region having data to be written to the far memory is a zero state, the operation is completed (block 244) by the far memory controller 214 (FIG. 5) without writing data to the far memory since it was determined that the region contained all zeroes. Thus, in that the regionU0 was determined (block 230) to contain all zeroes in the example of FIG. 7b, and a zero was stored (block 234, FIG. 4a) in the associated metadata entry of the data structure 310b (FIG. 7b) for the regionU0, the write operation is “completed” (block 244) without writing data to the far memory since it was determined that the regionU0 contained all zeroes as indicated by its associated metadata, obviating the need to store the data in the far memory. In this manner, data traffic storing data from the near memory into the far memory may be avoided for regions having as associated metadata value equal to zero in the example of FIG. 7b.

Conversely, if it is determined (block 250, FIG. 4a) that the metadata for a region to be written to the far memory is a one state, the far memory controller 214 (FIG. 5) of the inter-memory transfer interface logic 120 is configured to complete (block 254) the write operation by transmitting a block of data of the region without prior compression (thereby selectively bypassing the compression operation of block 260) and thus storing the data in the far memory uncompressed. Thus, in that the regionU1 was determined (block 230) to contain a mixture of ones and zeroes in the example of FIG. 7b, and a one was stored (block 234, FIG. 4a) in the associated metadata entry of the data structure 310b (FIG. 7b) for the regionU1, the “write” operation is completed (block 254) by transmitting the data of the regionU1 without prior compression and thus storing the data in the far memory uncompressed.

FIG. 4b is directed to a subsequent read operation from the far memory which begins with a read operation (block 270) by the far memory controller 214 which reads from the near memory, the metadata previously stored (block 234, FIG. 4a) for the region having the sector to be read from the far memory. In one embodiment, the metadata may be read directly from the near memory by the far memory controller 214 or in another embodiment may be read utilizing the near memory controller 210. In the example of FIG. 7b, the metadata will indicate (block 274 (FIG. 4b)) whether the data needs to be read by the far memory controller 214 from the far memory (metadata=one) or if the read operation from the far memory may be bypassed (metadata=zero) because the data is all zeroes (block 280, FIG. 4b) therefore saving traffic from the far memory.

For example, in that the regionU0 was determined (block 230) to contain all zeroes in the example of FIG. 7b, and a zero was stored (block 234, FIG. 4a) in the associated metadata entry of the data structure 310b (FIG. 7b) for the regionU0, the read operation for a sector of regionU0 from the far memory may be bypassed (block 280) by the far memory controller 214 of the inter-memory transfer interface logic 120. As a result, the reading of a sector of data for the regionU0 from the far memory may be avoided since it was determined that the regionU0 contained all zeroes as indicated by its associated metadata, obviating the need to read the data in the far memory. If appropriate, a sector of zeroes may be created using any suitable logic for responding to the read request.

Conversely, in that the regionU1 was determined (block 230) to contain a mixture of ones and zeroes in the example of FIG. 7b, and a one was stored (block 234, FIG. 4a) in the associated metadata entry of the data structure 310b (FIG. 7b) for the regionU1, the “write” operation of the block of data was completed (block 254) by the far memory controller 214 of the inter-memory transfer interface logic 120, transmitting the block of data of the regionU1 without prior compression and thus storing the block of data in the far memory uncompressed. Accordingly, the far memory sector containing the sector of data to be read may be identified (block 284, FIG. 4b) by the data location identification logic 134 of the far memory controller 214 as the original, unchanged sector since the data was not compressed prior to being transmitted to the far sector. In this manner, the far memory sector containing the data to be read may be identified as a function of the metadata for the region.

Having identified (block 284) the far memory sector containing the data to be read, the identified far memory sector is read (block 290) by the far memory controller 214 and processed as a function of region metadata to restore the read sector. If the sector data was compressed prior to being stored in the far memory, the processing will include decompressing the read data to restore the data. However, in the example of FIG. 7b, the metadata for the memory regionU1 is equal to one, indicating that the data was transferred and stored in the far memory without being first compressed. Accordingly, the data read from a sector of the memory regionU1 stored in the far memory may be read from the far memory and restored without decompression.

As previously mentioned, FIG. 7a shows an example of a data structure 310a in which the metadata stored for each region has two bits of metadata, such that the metadata has the capacity to identify up to four different compression/decompression processes in that the metadata has four possible states, 00, 01, 10 and 11. In one embodiment, the compression/decompression process assigned to the metadata state 00 may be the same as that assigned to the metadata state 0 of FIG. 7b. Thus, in the example of FIG. 7a, regionU0 is determined (block 230, FIG. 4a) to contain all zeroes and therefore a 00 is stored (block 234, FIG. 4a) in the associated metadata entry of the data structure 310a (FIG. 7a). Similarly regionU2 is all zeroes and therefore a 00 is stored in the associated metadata as shown in FIG. 7a.

As previously mentioned, in the illustrated embodiment, the data of each region is arranged in blocks, blockU0 (FIG. 6), blockU1, blockU2, blockU3, wherein each block has four sectors of uncompressed data, that is, a kilobyte (1024 bytes) of uncompressed data. Thus, in the example of FIG. 6, the region 610 has a first blockU0 of four sectors, that is, sectorU00, sectorU01, sectorU02 and sectorU03 of uncompressed data, a second blockU1 of four sectors, that is, sectorU04-sectorU07 of uncompressed data, a third blockU2 of four sectors, that is, sectorU08-sectorU11 of uncompressed data, and a fourth blockU3 of four sectors, that is, sectorU12-sectorU15 of compressed data.

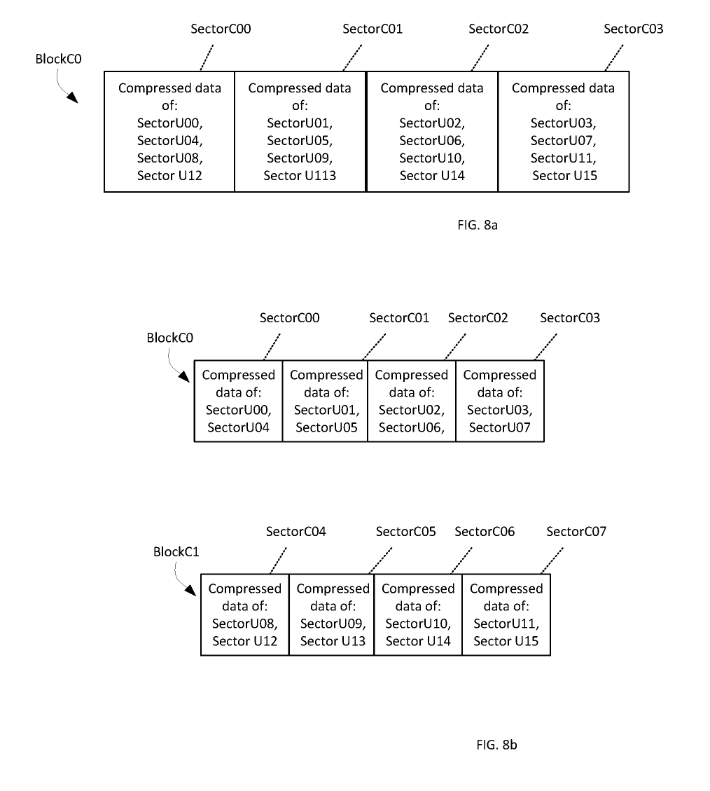

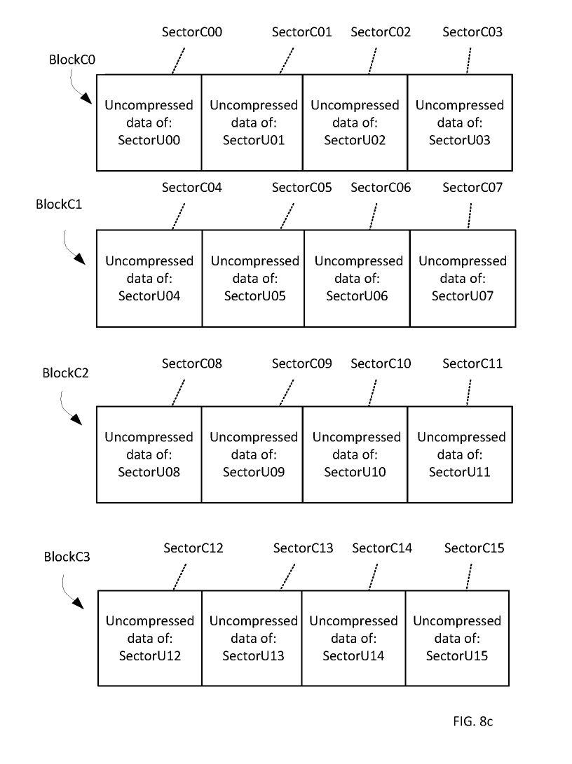

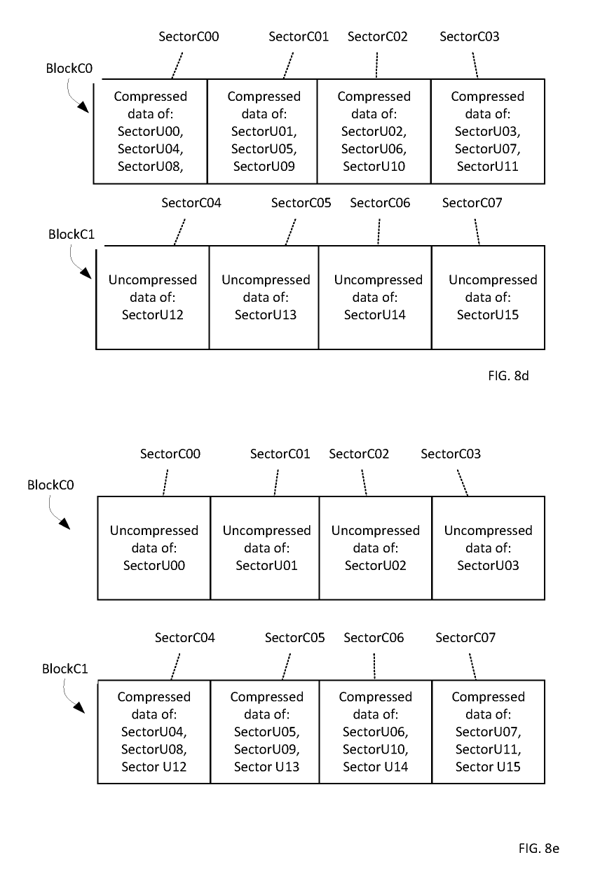

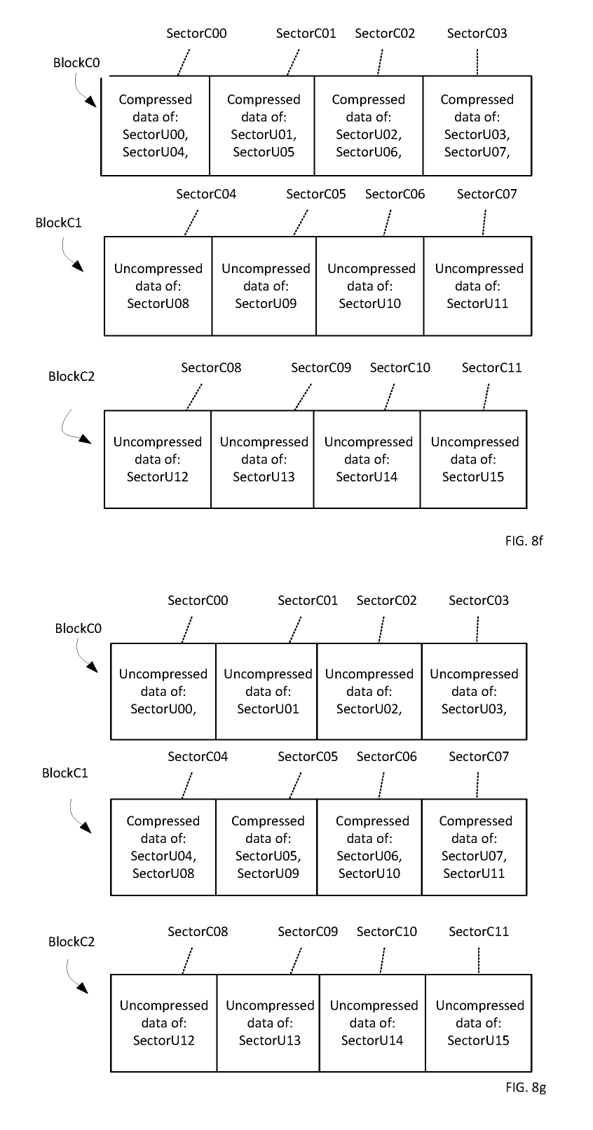

FIG. 8a shows an example of a compression/decompression process performed by the compression logic 130 of the far memory controller 214, which compresses all four blocks of a region 610 (FIG. 6) into one block, blockC0, of four sectors, sectorC0, sectorC1, sectorC2, sectorC3. Thus, for example, the data of the sectors sectorU00, sectorU04, sectorU08 and sectorU12 of the region 610 is compressed to the compressed sectorC00. In one aspect of the present description, each compressed sector is completely enclosed within one physical sector in far memory. As a result, the data for a compressed sector may be subsequently read by reading a single sector from the far memory. Moreover, in that a compression/decompression process may be selected from various candidate compression/decompression processes, depending upon which is most suitable to reduce the number of blocks to be transmitted for a particular region of data, enclosing a compressed sector completely within a physical sector of the far memory facilitates identifying the particular sector of the far memory containing the compressed sector.

In a similar manner, the data of the sectors sectorU01, sectorU05, sectorU09 and sectorU13 of the region 610 is compressed to the compressed sectorC01, the data of the sectors sectorU02, sectorU06, sectorU10 and sectorU14 of the region 610 is compressed to the compressed sectorC02, and data of the sectors, sectorU03, sectorU07, sectorU11 and sectorU15 of the region 610 is compressed to the compressed sectorC03. Data compressed using the compression/decompression process of FIG. 8a is assigned the metadata value 01, in this example, as shown for the regionU4 in the example of FIG. 7a.

FIG. 8b shows an example of a compression/decompression process performed by the compression logic 130 of the far memory controller 214, which compresses the data of the four blocks of a region 610 (FIG. 6) into two blocks, blockC0, blockC1, of four sectors each. In this example, the data of the sectors sectorU00, sectorU04, of the region 610 is compressed to the compressed sectorC00 of the blockC0. In a similar manner, the data of the sectors sectorU01, sectorU05, of the region 610 is compressed to the compressed sectorC01, the data of the sectors sectorU02, sectorU06, of the region 610 is compressed to the compressed sectorC02, and the data of the sectors, sectorU03, sectorU07, of the region 610 is compressed to the compressed sectorC03, of the block blockC0.

In a similar manner, the data of the sectors, sectorU08 and sectorU12, of the region 610 is compressed to the compressed sectorC04 of the blockC1 Further, the data of the sectors sectorU09 and sectorU13 of the region 610 is compressed to the compressed sectorC05, the data of the sectors sectorU10 and sectorU14 of the region 610 is compressed to the compressed sectorC06, and the data of the sectors, sectorU11 and sectorU15 of the region 610 is compressed to the compressed sectorC07, of the blockC1. Data compressed using the compression/decompression process of FIG. 8b is assigned the metadata value 10, in this example, as shown for the regionU1 in the example of FIG. 7a.

FIG. 8c depicts a compression/decompression process by the compression logic 130 in which bits are transmitted by the compression logic 130 of the far memory controller 214, to the far memory unchanged from the near memory, that is, without prior compression, and are read from the far memory without decompression in a manner similar to that described above for metadata state 1 in the example of FIG. 7b. Thus, the data of the blocks blockU0-blockU3 (FIG. 6) of the region 610 remains unchanged in the blocks blockC0-blockC3 (FIG. 8c) of the data transmitted to the far memory. Accordingly, the sector position of the data within a region does not change from that depicted in FIG. 6 before or after transmission between the near and far memory in the process of FIG. 8c. Similarly, the data content of each sector remains unchanged before or after transmission between the near and far memory in the process of FIG. 8c.

Thus, the data of the sectors, sectorU00, sectorU01, sectorU02, sectorU03 of the blockU0 of the region 610 (FIG. 6) remains unchanged as the sectors, sectorC00, sectorC01, sectorC02, sectorC03, respectively, of the blockC0 (FIG. 8c). The data of the sectors, sectorU04, sectorU05, sectorU06, sectorU07 of the blockU1 of the region 610 (FIG. 6) remains unchanged as the sectors, sectorC04, sectorC05, sectorC06, sectorC07, respectively, of the blockC2 (FIG. 8c). The data of the sectors, sectorU08, sectorU09, sectorU10, sectorU11 of the blockU2 of the region 610 remains unchanged as the sectors, sectorC08, sectorC09, sectorC10, sectorC11, respectively, of the blockC2 (FIG. 8c). The data of the sectors, sectorU12, sectorU13, sectorU14, sectorU15 of the blockU3 of the region 610 remains unchanged as the sectors, sectorC12, sectorC13, sectorC14, sectorC15, respectively, of the blockC3 (FIG. 8c). Data processed using the no-compression process of FIG. 8c is assigned the metadata value 11, in this example, as shown for the regionU3 in the example of FIG. 7a.

FIG. 7c shows an example of a data structure 310c in which the metadata stored for each region has three bits of metadata, such that the metadata has the capacity to identify up to eight different compression/decompression processes in that the metadata has eight possible states, 000, 001, 010, 011, 100, 101, 110 and 111. In one embodiment, the compression/decompression processes assigned to the metadata states 000, 001, 010, 011 may be the same as that assigned to the metadata states 00, 01, 10, 11 described above in connection with FIG. 7a.

FIG. 8d shows an example of a compression/decompression process by the compression logic 130 which compresses the data of blocks blockU0, blockU1 and blockU2 of a region 610 (FIG. 6) into one block, blockC0. In this example, the data of the sectors sectorU00, sectorU04, and sectorU08 of the region 610 (FIG. 6) is compressed to the compressed sectorC00 of the blockC0 (FIG. 8d). In a similar manner, the data of the sector sectorU01, sectorU05, and sectorU09 of the region 610 is compressed to the compressed sectorC01, the data of the sectors, sectorU02, sectorU06, and sectorU10 of the region 610 is compressed to the compressed sectorC02 (FIG. 8d), and the data of the sectors, sectorU03, sectorU07, and sectorU11 of the region 610 (FIG. 6) is compressed to the compressed sectorC03 of the blockC0 (FIG. 8d). The data of the sectors, sectorU12, sectorU13, sectorU14, sectorU15 of the blockU3 of the region 610 remains unchanged as the sectors, sectorC04, sectorC05, sectorC06, sectorC07, respectively, of the blockC1 (FIG. 8d). Accordingly, the data content of each sector of the blockU3 remains unchanged before transmission to the far memory as the blockC1 in the process of FIG. 8d. Conversely, the data content of each sector of the blockC1 (FIG. 8d) remains unchanged after transmission from the far memory to the near memory as the blockC1 in the process of FIG. 8d. Data processed using the compression/decompression process of FIG. 8d is assigned the metadata value 100, in this example, as shown for the regionU8 in the example of FIG. 7c.

FIG. 8e shows an example of a compression/decompression process by the compression logic 130 in which sectors, sectorU00, sectorU01, sectorU02, sectorU03 of the blockU0 of the region 610 (FIG. 6) remain unchanged as the sectors, sectorC00, sectorC01, sectorC02, sectorC03, respectively, of the blockC0 (FIG. 8e). Accordingly, the data content of each sector of the blockU0 remains unchanged before transmission to the far memory in the process of FIG. 8e. Similarly, the data content of each sector of the blockC0 (FIG. 8e) remains unchanged after transmission from the far memory to the near memory in the process of FIG. 8e.

However, the compression/decompression process of FIG. 8e compresses blocks, blockU1, blockU2 and blockU3, of a region 610 (FIG. 6) into one block, blockC1. In this example, the data of the sectors, sectorU04, sectorU08, sectorU12 of the region 610 (FIG. 6) is compressed to the compressed sectorC04 of the blockC1 (FIG. 8e). In a similar manner, the data of the sectors sectorU05, sectorU09, sectorU13 of the region 610 is compressed to the compressed sectorC05, the data of the sectors, sectorU06, sectorU10, sectorU14, of the region 610 is compressed to the compressed sectorC06 (FIG. 8r), and the data of the sectors, sectorU07, sectorU11, sectorU15 of the region 610 (FIG. 6) is compressed to the compressed sectorC07 of the blockC1 (FIG. 8e). Data processed using the compression/decompression process of FIG. 8e is assigned the metadata value 101, in this example, as shown for the regionU7 in the example of FIG. 7c.

FIG. 8f shows an example of a compression/decompression process by the compression logic 130 which compresses blocks blockU0 and blockU1 of a region 610 (FIG. 6) into one block, blockC0. In this example, the data of the sectors sectorU00, and sectorU04 of the region 610 (FIG. 6) is compressed to the compressed sectorC00 of the blockC0 (FIG. 8f). In a similar manner, the data of the sectors, sectorU01, and sectorU05 of the region 610 is compressed to the compressed sectorC01, the data of the sectors sectorU02, and sectorU06 of the region 610 is compressed to the compressed sectorC02 (FIG. 8f), and the data of the sectors, sectorU03, and sectorU07 of the region 610 (FIG. 6) is compressed to the compressed sectorC03 of the blockC0 (FIG. 8f).

The data of the sectors, sectorU08, sectorU09, sectorU10, sectorU11 of the blockU3 of the region 610 remains unchanged as the sectors, sectorC04, sectorC05, sectorC06, sectorC07, respectively, of the blockC1 (FIG. 8f). The data of the sectors, sectorU12, sectorU13, sectorU14, sectorU15 of the blockU3 of the region 610 also remains unchanged as the sectors, sectorC08, sectorC09, sectorC10, sectorC11, respectively, of the blockC2 (FIG. 8f). Data processed using the compression/decompression process of FIG. 8f is assigned the metadata value 110, in this example, as shown for the regionU6 in the example of FIG. 7c.

FIG. 8g shows an example of a compression/decompression process by the compression logic 130 in which the data of the sectors, sectorU00, sectorU01, sectorU02, sectorU03 of the blockU0 of the region 610 (FIG. 6) remains unchanged as the sectors, sectorC00, sectorC01, sectorC02, sectorC03, respectively, of the blockC0 (FIG. 8g). The compression/decompression process of FIG. 8g compresses blocks blockU1 and blockU2 of a region 610 (FIG. 6) into one block, blockC1. In this example, the data of the sectors sectorU04, and sectorU08 of the region 610 (FIG. 6) is compressed to the compressed sectorC04 of the blockC1 (FIG. 8g). In a similar manner, the data of the sectors, sectorU05, and sectorU09 of the region 610 is compressed to the compressed sectorC05, the data of the sectors sectorU06, and sectorU10 of the region 610 is compressed to the compressed sectorC06 (FIG. 8g), and the data of the sectors, sectorU07, and sectorU11 of the region 610 (FIG. 6) is compressed to the compressed sectorC07 of the blockC1 (FIG. 8g).

The data of the sectors, sectorU12, sectorU13, sectorU14, sectorU15 of the blockU3 of the region 610 remains unchanged as the sectors, sectorC08, sectorC09, sectorC10, sectorC11, respectively, of the blockC2 (FIG. 8g). Data processed using the compression/decompression process of FIG. 8g is assigned the metadata value 111, in this example, as shown for the regionU5 in the example of FIG. 7c.

In one aspect of the present description, each compressed sector of the various compression/decompression processes depicted in FIGS. 8a-8g, is completely enclosed within one physical sector in far memory. As a result, the data for a compressed sector may be subsequently read by reading a single sector from the far memory. Moreover, in that a compression/decompression process may be selected from various candidate compression/decompression processes, depending upon which is more suitable to reduce the number of blocks to be transmitted for a particular region of data, enclosing a compressed sector completely within a physical sector of the far memory facilitates identifying the particular sector of the far memory containing the compressed sector.

It is appreciated that other compression/decompression processes may be utilized depending upon the particular application. For example, different combinations of compressed and uncompressed sectors may be implemented to reduce data transmission and reduce power consumption. Also, in some embodiments, the data of a compressed sector may span over more than one physical sector of the far memory, for example. Further, it is appreciated that the arrangement and numbers of resultant compressed blocks and the sectors within those blocks may vary, depending upon the particular application.

In an example of a write operation depicted in FIG. 4a in connection with assignment of multiple bits of metadata, a compression/decompression process is selected (block 230) by the compression/decompression selection logic 122 (FIG. 5) examining the region of data from which the write data was obtained (block 224). The compression/decompression selection logic 122 of the far memory controller 214 selects (block 230, FIG. 4a) a compression/decompression process (such as one of the compression/decompression processes depicted in FIGS. 8a-8g, for example) to compress (or leave uncompressed) the data of one or more blocks of the memory region 610 (FIG. 6) of the near memory 110a before the processed data is transmitted to and stored in the far memory 110b. In one embodiment, the compression/decompression selection logic 122 of the far memory controller 214 selects (block 230, FIG. 4a) a compression/decompression process to compress the data of the memory region 610 (FIG. 6) so that the fewest number of blocks after compression are needed to write the data to the far memory 110b, but will still allow a read operation to access a single 256 byte sector from the far memory 110b. The metadata storage logic 124 of the far memory controller 214 stores (block 234, FIG. 4a) metadata in a data structure such as those depicted in FIGS. 7a-7c, for example, to indicate the particular compression/decompression process selected to compress the data of the memory region 610 for transmission to the far memory 110b.

In an example of a write operation depicted in FIG. 4a in connection with assignment of multiple bits of metadata, a compression/decompression process is selected (block 230) by examining the region of data from which the write data was obtained (block 234) to determine if it contains all zeroes or a mixture of ones and zeroes. Thus, in the example of FIG. 7a (two bits of metadata per region), regionU0 is determined (block 230) to contain all zeroes and therefore a 00 is stored (block 234, FIG. 4a) in the associated metadata entry of the data structure 310a (FIG. 7a). Similarly regionU2 is all zeroes and therefore a 00 is stored in the associated metadata as shown in FIG. 7a.

If it is determined (block 240, FIG. 4a) that the metadata for a region to be written to the far memory is a 00 state (or 000 state for three bits of metadata), the operation is completed (block 244) without writing data to the far memory since it was determined that the region contained all zeroes. Thus, in that the regionU0 was determined (block 230) to contain all zeroes in the example of FIG. 7a, and a 00 was stored (block 234, FIG. 4a) in the associated metadata entry of the data structure 310a (FIG. 7a) for the regionU0, the “write” operation is completed (block 244) without writing data to the far memory since it was determined that the regionU0 contained all zeroes as indicated by its associated metadata, obviating the need to store the data in the far memory. In this manner, the data traffic storing data from the near memory into the far memory may be avoided for regions having as associated metadata value equal to zero in the example of FIG. 7b.

Conversely, if it is determined (block 250, FIG. 4a) that the metadata for a region to be written to the far memory is a 11 state (or 011 state for three bit metadata), the write operation is completed (block 254) by transmitting the data of the region without prior compression (bypassing the compression operation of block 260) and thus storing the data in the far memory uncompressed. Thus, if it is determined (block 230) for example, that compression did not result in significant reduction in the number of blocks for the regionU3, a compression/decompression process may be selected such as that depicted in FIG. 8c which does not compress the data prior to transmission, and a metadata value 11 (or metadata value=011 for a three bit metadata) was stored (block 234, FIG. 4a) in the associated metadata entry of the data structure 310a (FIG. 7a) for the regionU3. The “write” operation to the far memory is completed (block 254) by transmitting the data of the regionU3 without prior compression and thus storing the data in the far memory uncompressed.

Conversely, if it is determined (block 250, FIG. 4a) that the metadata for a region to be written to the far memory is other than a 11 state (or other than a 011 state for three bit metadata), the data is compressed (block 260) using a compression/decompression process such as one depicted in FIGS. 8a, 8b, 8d-8g, for example, which has been selected to minimize the amount of traffic from the near memory to the far memory for the particular write operation. The write operation is completed (block 254) by transmitting the data of the region after compression by the compression logic 130 (FIG. 5) and then storing the compressed data in the far memory.

In an example of a read operation depicted in FIG. 4b in connection with an embodiment having multiple bits of metadata stored in a near memory for each region, a read operation (block 270) reads from the near memory, the metadata previously stored (block 234, FIG. 4a) for the region of the sector to be read from the far memory. If it is determined (block 240, FIG. 4a) that the metadata for a region is a 00 state (or 000 state for three bits of metadata), the read operation from the far memory may be bypassed (block 280, FIG. 4b) because the data is all zeroes therefore saving traffic from the far memory.

For example, if the regionU0 was determined (block 230, FIG. 4a) to contain all zeroes in the example of FIG. 7a, and a 00 was stored (block 234, FIG. 4a) in the associated metadata entry of the data structure 310a (FIG. 7a) for the regionU0, the read operation from the far memory may be bypassed (block 280). As a result, the reading of data for the regionU0 from the far memory may be avoided since it was determined that the regionU0 contained all zeroes as indicated by its associated metadata, obviating the need to read the data in the far memory.

Conversely, in that the region was determined (block 230) to contain a mixture of ones and zeroes (such that metadata does not equal 0, 00 or 000), the far memory sector containing the data to be read may be identified (block 284, FIG. 4b) by the data location identification logic 134 (FIG. 5) as a function of the metadata read (block 270, FIG. 4b) for the region. For example, if the read operation is directed to original sectorU08 (FIG. 6) of the blockU2 of the original memory regionU4 (FIG. 7a), the data structure 310a of FIG. 7a indicates that the metadata read for the memory regionU4 has a value equal to 01. As previously mentioned, the metadata value 01 may be assigned to the compression/decompression process depicted in FIG. 8a, for example. In the compression/decompression process of FIG. 8a, the sector location of the compressed data containing the compressed data of sectorU08 may be identified (block 284, FIG. 4b) as the sectorC00 of the blockC0. Accordingly, the sectorC00 of the blockC0 is read (block 290) from the far memory and decompressed by the decompression logic 140 (FIG. 5) in accordance with the compression/decompression process of FIG. 8a used to compress the block blockU2 of the original memory regionU4. In this manner, the uncompressed data of the original sectorU08 (FIG. 6) of the blockU2 of the original memory regionU4 may be restored and stored in the near memory. In the process of FIG. 8a, the sector location of the compressed data containing the compressed data of the original sector may be calculated (block 284, FIG. 4b) as a function of the original sector number and the metadata value, such as N modulo 4 where N is the original sector number, for example, for metadata value equal to 01 (or 001 for a three metadata bit embodiment), for example. If appropriate, the other sectors compressed into the read sector may be restored as well and made available. Thus, the other sectors, sectorU00, sectorU04 and sectorU12, compressed into the read sectorC00 may be restored as well and made available.

In another example, if the read operation is directed to original sectorU08 (FIG. 6) of the blockU2 of the original memory regionU1 (FIG. 7a), the data structure 310a of FIG. 7a indicates that the metadata read for the memory regionU1 has a value equal to 10. As previously mentioned, the metadata value 10 may be assigned to the compression/decompression process depicted in FIG. 8b, for example. In the compression/decompression process of FIG. 8b, the sector location of the compressed data containing the compressed data of sectorU08 may be identified (block 284, FIG. 4b) as the sectorC04 of the blockC1. Accordingly, the sectorC04 of the blockC1 is read (block 290) from the far memory and decompressed by the decompression logic 140 (FIG. 5) in accordance with the compression/decompression process of FIG. 8b used to compress the block blockU2 of the original memory regionU1. In this manner, the uncompressed data of the original sectorU08 (FIG. 6) of the blockU2 of the original memory regionU1 may be restored and stored in the near memory. In the process of FIG. 8b, the sector location of the compressed data containing the compressed data of original sector may be calculated (block 284, FIG. 4b) as a function of the original sector number and the metadata value, such as N modulo 4 where N is the original sector number from 0-7, and as 4 plus N modulo 4 where N is the original sector from 8-15, for example, for metadata value equal to 10 (or 010 for a three metadata bit embodiment), for example.

In another example, if the read operation is directed to original sectorU08 (FIG. 6) of the blockU2 of the original memory regionU3 (FIG. 7a), the data structure 310a of FIG. 7a indicates that the metadata read for the memory regionU3 has a value equal to 11. As previously mentioned, the metadata value 11 may be assigned to the compression/decompression process depicted in FIG. 8c, for example, which leaves the data uncompressed. In the compression/decompression process of FIG. 8c, the sector location of the compressed data containing the uncompressed data of sectorU08 may be identified (block 284, FIG. 4b) as the sectorC08 of the blockC2. Accordingly, the sectorC08 of the blockC2 is read (block 290) from the far memory without being decompressed by the decompression logic 140 (FIG. 5) in accordance with the compression/decompression process of FIG. 8c used to process the block blockU2 of the original memory regionU3. In this manner, the uncompressed data of the original sectorU08 (FIG. 6) of the blockU2 of the original memory regionU3 may be restored and stored in the near memory. In the process of FIG. 8c, the sector location of the uncompressed data containing the uncompressed data of the original sector may be calculated (block 284, FIG. 4b) as a function of the original sector number and the metadata value, such as equal to the same sector number as the original sector number, for example, for metadata value equal to 011, for example.

In another example, if the read operation is directed to original sectorU08 (FIG. 6) of the blockU2 of the original memory regionU8 (FIG. 7c), the data structure 310c of FIG. 7c indicates that the metadata read for the memory regionU8 has a value equal to 100. As previously mentioned, the metadata value 100 may be assigned to the compression/decompression process depicted in FIG. 8d, for example. In the compression/decompression process of FIG. 8d, the sector location of the compressed data containing the compressed data of sectorU08 may be identified (block 284, FIG. 4b) as the sectorC00 of the blockC0. Accordingly, the sectorC00 of the blockC0 is read (block 290) from the far memory and decompressed by the decompression logic 140 (FIG. 5) in accordance with the compression/decompression process of FIG. 8d used to compress the block blockU2 of the original memory regionU8. In this manner, the uncompressed data of the original sectorU08 (FIG. 6) of the blockU2 of the original memory regionU8 may be restored and stored in the near memory. In the process of FIG. 8d, the sector location of the compressed data containing the compressed data of original sector may be calculated (block 284, FIG. 4b) as a function of the original sector number and the metadata value, such as N modulo 4 where N is the original sector number from 0-11, and as 4 plus N modulo 4 where N is the original sector number from 12-15, for example, for metadata value equal to 100, for example.

In another example, if the read operation is directed to original sectorU08 (FIG. 6) of the blockU2 of the original memory regionU7 (FIG. 7c), the data structure 310c of FIG. 7c indicates that the metadata read for the memory regionU7 has a value equal to 101. As previously mentioned, the metadata value 101 may be assigned to the compression/decompression process depicted in FIG. 8e, for example. In the compression/decompression process of FIG. 8e, the sector location of the compressed data containing the compressed data of sectorU08 may be identified (block 284, FIG. 4b) as the sectorC04 of the blockC1. Accordingly, the sectorC04 of the blockC1 is read (block 290) from the far memory and decompressed by the decompression logic 140 (FIG. 5) in accordance with the compression/decompression process of FIG. 8e used to compress the block blockU2 of the original memory regionU7. In this manner, the uncompressed data of the original sectorU08 (FIG. 6) of the blockU2 of the original memory regionU7 may be restored and stored in the near memory. In the process of FIG. 8e, the sector location of the compressed data containing the compressed data of original sector may be calculated (block 284, FIG. 4b) as a function of the original serial number and the metadata value, such as having the same sector number as the original sector number, for original sector numbers from 0-3, and as 4 plus N modulo 4 where N is the original sector from 4-15, for example, for metadata value equal to 101, for example.

In another example, if the read operation is directed to original sectorU08 (FIG. 6) of the blockU2 of the original memory regionU6 (FIG. 7c), the data structure 310c of

FIG. 7c indicates that the metadata read for the memory regionU6 has a value equal to 110. As previously mentioned, the metadata value 110 may be assigned to the compression/decompression process depicted in FIG. 8f, for example. In the compression/decompression process of FIG. 8f, the sector location of the uncompressed data obtained from sectorU08 may be identified (block 284, FIG. 4b) as the sectorC04 of the blockC1. Accordingly, the sectorC04 of the blockC1 is read (block 290) from the far memory without being decompressed by the decompression logic 140 (FIG. 5) in accordance with the compression/decompression process of FIG. 8f used to process the block blockU2 of the original memory regionU6. In this manner, the uncompressed data of the original sectorU08 (FIG. 6) of the blockU2 of the original memory regionU6 may be restored and stored in the near memory. In the process of FIG. 8f, the sector location of the compressed data containing the compressed data of original sector may be calculated (block 284, FIG. 4b) as function of the original sector number and the metadata value, such as N modulo 4 where N is the original sector number from 0-7, as 4 plus N modulo 4 where N is the original sector number from 8-11, and as 8 plus N modulo 4 where N is the original sector number from 12-15, for example, for metadata value equal to 110, for example.

In another example, if the read operation is directed to original sectorU08 (FIG. 6) of the blockU2 of the original memory regionU5 (FIG. 7c), the data structure 310c of FIG. 7c indicates that the metadata read for the memory regionU5 has a value equal to 111. As previously mentioned, the metadata value 111 may be assigned to the compression/decompression process depicted in FIG. 8g, for example. In the compression/decompression process of FIG. 8g, the sector location of the compressed data compressed from the data obtained from sectorU08 may be identified (block 284, FIG. 4b) as the sectorC04 of the blockC1. Accordingly, the sectorC04 of the blockC1 is read (block 290) from the far memory and is decompressed by the decompression logic 140 (FIG. 5) in accordance with the compression/decompression process of FIG. 8g used to process the block blockU2 of the original memory regionU5. In this manner, the uncompressed data of the original sectorU08 (FIG. 6) of the blockU2 of the original memory regionU5 may be restored and stored in the near memory. In the process of FIG. 8g, the sector location of the compressed data containing the compressed data of original sector may be calculated (block 284, FIG. 4b) as a function of the original sector number and the metadata value, such as equal to N where N is the original sector number from 0-3, as 4 plus N modulo 4 where N is the original sector number from 4-11, and as 8 plus N modulo 4 where N is the original sector number from 12-15, for example, for metadata value equal to 111, for example.

A sector read from the far memory and processed in accordance with the decompression process identified by the associated metadata of the region, may be stored in the near memory directly by the far memory controller 214. However, it is appreciated that in some embodiments, the data may be stored in the near memory utilizing the near memory controller 210.

In another aspect of the present description, it is appreciated that in some embodiments, a region of data may be stored in the far memory and some but not all sectors of that region may be cached in the near memory. In the event that one or more of those sectors is evicted from the near memory, operations may be undertaken to permit the evicted sectors to be transferred to the far memory utilizing an inter-memory transfer interface in accordance with the present description as a function of the stored metadata for the region and as a function of whether the region has been modified in the near memory.

For example, if the sectors being evicted from the near memory are from a region of data which has remained unchanged, transferring the evicted sectors back to the far memory may be bypassed since the sectors are already stored in the far memory. In addition, the metadata for the region may remain unchanged since the compression/decompression process selected for the region also remains unchanged.

In another example, if the sectors being evicted from the near memory are from a region of data which has been modified in the near memory but is uncompressed in the far memory, the modified sectors or blocks of sectors being evicted from the near memory may be transferred back to the far memory in uncompressed form without incurring any new sector reads from the far memory. In addition, the metadata for the region may remain unchanged since the compression/decompression process (which is a no compression process) selected for the region also remains unchanged.

In still another example, if the sectors being evicted from the near memory are from a region of data which has been modified in the near memory and is compressed in the far memory, sectors of the region which are missing in the near memory are read from the far memory so that the region of the modified sectors or blocks of sectors being evicted from the near memory may be recompressed and transferred to the far memory. If the compression/decompression process selected for the region remains unchanged, the metadata stored for the region may remain unchanged. However, if a different compression/decompression process is selected to recompress the region, the metadata stored for the region is also changed to indicate the new selected compression/decompression process.

In another aspect of the present description, metadata stored in the near memory may be copied to the far memory to preserve the metadata identifying the compression/decompression process selected for each region of data, in the event that the near memory goes to a low power state, sleep state or other state which may make the metadata unavailable or corrupted. Accordingly, a small portion of the far memory may be reserved to store a copy of the metadata.

It is appreciated that the operations of FIGS. 4a, 4b may be performed by an inter-memory transfer interface having selective data compression/decompression utilizing architectures other than that depicted in FIGS. 1, 3 and 5 and employing other types of logic components. The logic components discussed herein including the logic elements depicted in FIGS. 1, 3 and 5 may be configured to perform the described operations using appropriate hardware, software or firmware, or various combinations thereof. The software may be in the form of programs, drivers and other instruction sets, and the hardware may be in the form of general purpose logic devices such as microprocessors or specific purpose logic devices such as a memory controller, DMA controller or engine or ASIC device, for example.

The hardware, software or firmware of the inter-memory transfer interface may be physically or logically located in any component of the system including the memory itself, a controller such as a memory controller, DMA controller, a microprocessor, etc. Thus, in one embodiment, one or more of the logic elements depicted in FIGS. 1, 3 and 5, for example, may be implemented with one or more of hardware of a memory controller, firmware for a memory controller, and software such as associated driver software of a memory controller. In another embodiment, one or more of the logic elements depicted in FIGS. 1, 3 and 5, may be implemented with one or more of controller hardware such as the central processing unit CPU1, for example, or other controller, firmware for the controller hardware and software for the controller hardware such as programs and drivers executed by the controller hardware such as the central processing unit CPU1, for example. In another embodiment, one or more of the logic elements depicted in FIGS. 1, 3 and 5, may be implemented with hardware, firmware or software for both an offload data transfer engine and a central processing unit, for example.

It is appreciated that an inter-memory transfer interface having selective data compression/decompression in accordance with the present description can, depending upon the particular application, reduce data traffic between a near memory and a far memory, and improve system efficiency. Other aspects may be achieved, depending upon the particular application.

### EXAMPLES

The following examples pertain to further embodiments.

Example 1 is a system, comprising: a central processing unit, a memory subsystem including a plurality of memories including a first memory having a first region, and a second memory, and inter-memory transfer interface logic configured to control input/output operations for said memory subsystem wherein the inter-memory transfer interface logic is configured to store in the first region a plurality of units of data, each unit of data including a plurality of subunits of data, including a first subunit of data, said inter-memory transfer interface logic including: compression/decompression selection logic configured to select a compression process to compress a first plurality of subunits of data of the first region including the first subunit of data, metadata storage logic configured to store metadata to indicate a compression process selected for the first subunit of data, and compression logic configured to compress the first plurality of subunits of data of the first region with a selected compression process to provide at least a second subunit of data compressed data so that the second subunit of data encloses in compressed form the data of the first plurality of subunits of data including the first subunit of data, and wherein the inter-memory transfer interface logic is further configured to transmit a unit of compressed data to the second memory wherein the transmitted unit of compressed data includes multiple subunits of compressed data including said second subunit of data, and to store the unit of compressed data in the second memory.

In Example 2, the subject matter of Examples 1-9 (excluding the present Example) can optionally include wherein each subunit of data has a subunit identification, and the inter-memory transfer interface logic further includes data location identification logic configured to read metadata indicating a compression process selected for the first subunit of data, and identify the second subunit of compressed data stored in the second memory as containing the first subunit of data as a function of the read metadata indicating the compression process selected for the first subunit of data and as a function of a subunit identification of the first subunit of data,

wherein the inter-memory transfer interface logic is further configured to read the second subunit of compressed data from the second memory, and further includes decompression logic configured to receive and decompress the second subunit of compressed data from the second memory as a function of the read metadata indicating the compression process selected for the second subunit data, to restore the first subunit of data of the from the second subunit of compressed data, and

wherein the inter-memory transfer interface logic is further configured to store a restored first subunit of data in the first memory.

In Example 3, the subject matter of Examples 1-9 (excluding the present Example) can optionally include wherein the compression/decompression selection logic is further configured to select a compression process for compression of the first region of data, wherein the metadata storage logic is further configured to store at least one bit of metadata for the first region of data to indicate a compression process selected for the first region of data wherein the metadata for the first region of data has a first defined state if all bits of the first region have a single common state and wherein the inter-memory transfer interface logic is further configured to selectively bypass compression and transmission of the first region of data to the second memory if the metadata for the first region of data has the first defined state, and wherein the metadata for the first region of data has a second, different defined state if bits of the first region have states other than the single common state and wherein the inter-memory transfer interface logic is further configured to transmit data of the first region of data to the second memory if the metadata for the first region of data has the second defined state.

In Example 4, the subject matter of Examples 1-9 (excluding the present Example) can optionally include wherein the metadata storage logic is further configured to store at least two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

In Example 5, the subject matter of Examples 1-9 (excluding the present Example) can optionally include wherein the metadata storage logic is further configured to store at least three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

In Example 6, the subject matter of Examples 1-9 (excluding the present Example) can optionally include wherein the metadata for the first region of data has a sixth defined state if the compression process selected for the first region leaves a second unit of data of the first region as a unit of uncompressed data and compresses a plurality of units of data of the first region into a unit of compressed data.

In Example 7, the subject matter of Examples 1-9 (excluding the present Example) can optionally include wherein the compression/decompression selection logic is further configured to select a compression process to compress the first region of data, wherein the metadata storage logic is further configured to store at least one bit of metadata for the first region of data to indicate a compression process selected for the first region of data wherein the metadata for the first region of data has a first defined state if the first region of data is compressed in a first compression process, and wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

In Example 8, the subject matter of Examples 1-9 (excluding the present Example) can optionally include wherein the compression/decompression selection logic is further configured to select a different compression process for compression of the first region of data which is different from the first compression process, wherein the metadata storage logic is further configured to update the metadata for the first region to have a different defined state to indicate the different compression process if the first region of data is compressed in the different compression process.

In Example 9, the subject matter of Examples 1-9 (excluding the present Example) can optionally include at least one of:

a display communicatively coupled to the central processing unit, a network interface communicatively coupled to the central processing unit, and a battery coupled to provide power to the system.

Example 10 is a method, comprising: selecting a compression process for selectively compressing a plurality of units of data from a first region of data of a first memory, each unit of data including a plurality of subunits of data, storing metadata indicating a compression process selected for the first region of data, and as a function of the selected compression process, selectively: compressing the plurality of units of data to provide at least a second unit of compressed data including a plurality of subunits of compressed data using a selected compression process so that each subunit of compressed data encloses in compressed form the data of a subunit of the first plurality of units of data, transmitting the second unit of compressed data to a second memory, and storing the second unit of compressed data in the second memory.

In Example 11, the subject matter of Examples 10-17 (excluding the present Example) can optionally include wherein each subunit of data of the plurality of units of data has a subunit identification. the method further comprising: reading metadata indicating a compression process selected for the first region of data, identifying a location of a subunit of compressed data stored in the second memory as containing a particular subunit of data of the first plurality of units of data as a function of the read metadata indicating the compression process selected for the first region of data and as a function of the subunit identification of the particular subunit of data, reading and transmitting a located subunit of compressed data from the second memory, receiving and decompressing the located subunit of compressed data from the second memory, as a function of the read metadata indicating the compression process selected for the region of data, to restore the particular subunit of data from the located subunit of compressed data, and storing a restored particular subunit of data in the first memory.

In Example 12, the subject matter of Examples 10-17 (excluding the present Example) can optionally include selecting a compression process for compressing the first region of data, wherein the metadata storing includes storing a bit of metadata for the first region of data to indicate a compression process selected for the first region of data wherein the metadata for the first region of data has a first defined state if all bits of the first region have a single common state and the transmitting and storing are selectively bypassed if the metadata for the first region of data has the first defined state, and wherein the metadata for the first region of data has a second, different defined state if bits of the first region have states other than the single common state and the transmitting is selectively performed if the metadata for the first region of data has the second defined state.

In Example 13, the subject matter of Examples 10-17 (excluding the present Example) can optionally include wherein the metadata storing includes storing two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

In Example 14, the subject matter of Examples 10-17 (excluding the present Example) can optionally include wherein the metadata storing includes storing three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

In Example 15, the subject matter of Examples 10-17 (excluding the present Example) can optionally include wherein the metadata for the first region of data has a sixth defined state if the compression process selected for the first region leaves a second unit of data of the first region as a unit of uncompressed data and compresses a plurality of units of data of the first region into a unit of compressed data.

In Example 16, the subject matter of Examples 10-17 (excluding the present Example) can optionally include selecting a compression process for compressing the first region of data, wherein the metadata storing includes storing at least one bit of metadata for the first region of data to indicate a compression process selected for the first region of data wherein the metadata for the first region of data has a first defined state if the first region of data is compressed in a first compression process, wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

In Example 17, the subject matter of Examples 10-17 (excluding the present Example) can optionally include wherein the selecting a compression process for compressing the first region of data includes selecting a different compression process for compression of the first region of data which is different from the first compression process, wherein the metadata storing includes updating the metadata for the first region to have a different defined state to indicate the different compression process if the first region of data is compressed in the different compression process.

Example 18 is an apparatus comprising means to perform a method as claimed in any preceding Example.

Example 19 is an apparatus for use with a memory subsystem including a plurality of memories including a first memory having a first region, and a second memory, comprising: inter-memory transfer interface logic configured to control input/output operations for said memory subsystem wherein the inter-memory transfer interface logic is configured to store in the first region a plurality of units of data, each unit of data including a plurality of subunits of data, including a first subunit of data, said inter-memory transfer interface logic including: compression/decompression selection logic configured to select a compression process to compress a first plurality of subunits of data of the first region including the first subunit of data, metadata storage logic configured to store metadata to indicate a compression process selected for the first subunit of data, and compression logic configured to compress the first plurality of subunits of data of the first region with a selected compression process to provide at least a second subunit of data compressed data so that the second subunit of data encloses in compressed form the data of the first plurality of subunits of data including the first subunit of data, and wherein the inter-memory transfer interface logic is further configured to transmit a unit of compressed data to the second memory wherein the transmitted unit of compressed data includes multiple subunits of compressed data including said second subunit of data, and to store the unit of compressed data in the second memory.

In Example 20, the subject matter of Examples 19-27 (excluding the present Example) can optionally include wherein each subunit of data has a subunit identification, and the inter-memory transfer interface logic further includes data location identification logic configured to read metadata indicating a compression process selected for the first subunit of data, and identify the second subunit of compressed data stored in the second memory as containing the first subunit of data as a function of the read metadata indicating the compression process selected for the first subunit of data and as a function of a subunit identification of the first subunit of data, wherein the inter-memory transfer interface logic is further configured to read the second subunit of compressed data from the second memory, and further includes decompression logic configured to receive and decompress the second subunit of compressed data from the second memory as a function of the read metadata indicating the compression process selected for the second subunit data, to restore the first subunit of data of the from the second subunit of compressed data, and wherein the inter-memory transfer interface logic is further configured to store a restored first subunit of data in the first memory.

In Example 21, the subject matter of Examples 19-27 (excluding the present Example) can optionally include wherein the compression/decompression selection logic is further configured to select a compression process for compression of the first region of data, wherein the metadata storage logic is further configured to store at least one bit of metadata for the first region of data to indicate a compression process selected for the first region of data wherein the metadata for the first region of data has a first defined state if all bits of the first region have a single common state and wherein the inter-memory transfer interface logic is further configured to selectively bypass compression and transmission of the first region of data to the second memory if the metadata for the first region of data has the first defined state, and wherein the metadata for the first region of data has a second, different defined state if bits of the first region have states other than the single common state and wherein the inter-memory transfer interface logic is further configured to transmit data of the first region of data to the second memory if the metadata for the first region of data has the second defined state.

In Example 22, the subject matter of Examples 19-27 (excluding the present Example) can optionally include wherein the metadata storage logic is further configured to store at least two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

In Example 23, the subject matter of Examples 19-27 (excluding the present Example) can optionally include wherein the metadata storage logic is further configured to store at least three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

In Example 24, the subject matter of Examples 19-27 (excluding the present Example) can optionally include wherein the metadata for the first region of data has a sixth defined state if the compression process selected for the first region leaves a second unit of data of the first region as a unit of uncompressed data and compresses a plurality of units of data of the first region into a unit of compressed data.

In Example 25, the subject matter of Examples 19-27 (excluding the present Example) can optionally include wherein the compression/decompression selection logic is further configured to select a compression process to compress the first region of data, wherein the metadata storage logic is further configured to store at least one bit of metadata for the first region of data to indicate a compression process selected for the first region of data wherein the metadata for the first region of data has a first defined state if the first region of data is compressed in a first compression process, and wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

In Example 26, the subject matter of Examples 19-27 (excluding the present Example) can optionally include wherein the compression/decompression selection logic is further configured to select a different compression process for compression of the first region of data which is different from the first compression process, wherein the metadata storage logic is further configured to update the metadata for the first region to have a different defined state to indicate the different compression process if the first region of data is compressed in the different compression process.

In Example 27, the subject matter of Examples 19-27 (excluding the present Example) can optionally include a system comprising: said inter-memory transfer interface logic, a central processing unit, a memory subsystem including a plurality of memories including a first memory having a first region, and a second memory, and at least one of:

a display communicatively coupled to the central processing unit, a network interface communicatively coupled to the central processing unit, and a battery coupled to provide power to the system.

Example 28 is an apparatus for use with a memory subsystem including a plurality of memories including a first memory having a first region, and a second memory, comprising: inter-memory transfer interface means for controlling input/output operations for said memory subsystem wherein the inter-memory transfer interface means is configured for storing in the first region a plurality of units of data, each unit of data including a plurality of subunits of data, including a first subunit of data, said inter-memory transfer interface means including: compression/decompression selection means for selecting a compression process to compress a first plurality of subunits of data of the first region including the first subunit of data, metadata storage means for storing metadata to indicate a compression process selected for the first subunit of data, and compression means for compressing the first plurality of subunits of data of the first region with a selected compression process to provide at least a second subunit of data compressed data so that the second subunit of data encloses in compressed form the data of the first plurality of subunits of data including the first subunit of data, and wherein the inter-memory transfer interface means is further configured for transmitting a unit of compressed data to the second memory wherein the transmitted unit of compressed data includes multiple subunits of compressed data including said second subunit of data, and to store the unit of compressed data in the second memory.

In Example 29, the subject matter of Examples 28-35 (excluding the present Example) can optionally include wherein each subunit of data has a subunit identification, and the inter-memory transfer interface means further includes data location identification means for reading metadata indicating a compression process selected for the first subunit of data, and for identifying the second subunit of compressed data stored in the second memory as containing the first subunit of data as a function of the read metadata indicating the compression process selected for the first subunit of data and as a function of a subunit identification of the first subunit of data, wherein the inter-memory transfer interface means is further configured for reading the second subunit of compressed data from the second memory, and further includes decompression means for receiving and decompressing the second subunit of compressed data from the second memory as a function of the read metadata indicating the compression process selected for the second subunit data, to restore the first subunit of data of the from the second subunit of compressed data, and wherein the inter-memory transfer interface means is further configured for storing a restored first subunit of data in the first memory.

In Example 30, the subject matter of Examples 28-35 (excluding the present Example) can optionally include wherein the compression/decompression selection means is further configured for selecting a compression process for compression of the first region of data, wherein the metadata storage means is further configured for storing at least one bit of metadata for the first region of data to indicate a compression process selected for the first region of data wherein the metadata for the first region of data has a first defined state if all bits of the first region have a single common state and wherein the inter-memory transfer interface means is further configured for selectively bypassing compression and transmission of the first region of data to the second memory if the metadata for the first region of data has the first defined state, and wherein the metadata for the first region of data has a second, different defined state if bits of the first region have states other than the single common state and wherein the inter-memory transfer interface means is further configured for transmitting data of the first region of data to the second memory if the metadata for the first region of data has the second defined state.

In Example 31, the subject matter of Examples 28-35 (excluding the present Example) can optionally include wherein the metadata storage means is further configured for storing at least two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

In Example 32, the subject matter of Examples 28-35 (excluding the present Example) can optionally include wherein the metadata storage means is further configured for storing at least three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

In Example 33, the subject matter of Examples 28-35 (excluding the present Example) can optionally include wherein the metadata for the first region of data has a sixth defined state if the compression process selected for the first region leaves a second unit of data of the first region as a unit of uncompressed data and compresses a plurality of units of data of the first region into a unit of compressed data.

In Example 34, the subject matter of Examples 28-35 (excluding the present Example) can optionally include wherein the compression/decompression selection means is further configured for selecting a compression process to compress the first region of data, wherein the metadata storage means is further configured for storing at least one bit of metadata for the first region of data to indicate a compression process selected for the first region of data wherein the metadata for the first region of data has a first defined state if the first region of data is compressed in a first compression process, and wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

In Example 35, the subject matter of Examples 28-35 (excluding the present Example) can optionally include wherein the compression/decompression selection means is further configured for selecting a different compression process for compression of the first region of data which is different from the first compression process, wherein the metadata storage means is further configured for updating the metadata for the first region to have a different defined state to indicate the different compression process if the first region of data is compressed in the different compression process.

Example 36 is a computer program product for a computing system wherein the computer program product comprises a computer readable storage medium having program instructions embodied therewith, the program instructions executable by a processor of the computing system to cause operations, the operations comprising:

selecting a compression process for selectively compressing a plurality of units of data from a first region of data of a first memory, each unit of data including a plurality of subunits of data, storing metadata indicating a compression process selected for the first region of data, and as a function of the selected compression process, selectively: compressing the plurality of units of data to provide at least a second unit of compressed data including a plurality of subunits of compressed data using a selected compression process so that each subunit of compressed data encloses in compressed form the data of a subunit of the first plurality of units of data, transmitting the second unit of compressed data to a second memory, and storing the second unit of compressed data in the second memory.

In Example 37, the subject matter of Examples 36-43 (excluding the present Example) can optionally include wherein each subunit of data of the plurality of units of data has a subunit identification. the operations further comprising: reading metadata indicating a compression process selected for the first region of data, identifying a location of a subunit of compressed data stored in the second memory as containing a particular subunit of data of the first plurality of units of data as a function of the read metadata indicating the compression process selected for the first region of data and as a function of the subunit identification of the particular subunit of data, reading and transmitting a located subunit of compressed data from the second memory, receiving and decompressing the located subunit of compressed data from the second memory, as a function of the read metadata indicating the compression process selected for the region of data, to restore the particular subunit of data from the located subunit of compressed data, and storing a restored particular subunit of data in the first memory.

In Example 38, the subject matter of Examples 36-43 (excluding the present Example) can optionally include wherein the operations further comprise selecting a compression process for compressing the first region of data, wherein the metadata storing includes storing a bit of metadata for the first region of data to indicate a compression process selected for the first region of data wherein the metadata for the first region of data has a first defined state if all bits of the first region have a single common state and the transmitting and storing are selectively bypassed if the metadata for the first region of data has the first defined state, and wherein the metadata for the first region of data has a second, different defined state if bits of the first region have states other than the single common state and the transmitting is selectively performed if the metadata for the first region of data has the second defined state.

In Example 39, the subject matter of Examples 36-43 (excluding the present Example) can optionally include wherein the metadata storing includes storing two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

In Example 40, the subject matter of Examples 36-43 (excluding the present Example) can optionally include wherein the metadata storing includes storing three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

In Example 41, the subject matter of Examples 36-43 (excluding the present Example) can optionally include wherein the metadata for the first region of data has a sixth defined state if the compression process selected for the first region leaves a second unit of data of the first region as a unit of uncompressed data and compresses a plurality of units of data of the first region into a unit of compressed data.

In Example 42, the subject matter of Examples 36-43 (excluding the present Example) can optionally include wherein the operations further comprise selecting a compression process for compressing the first region of data, wherein the metadata storing includes storing at least one bit of metadata for the first region of data to indicate a compression process selected for the first region of data wherein the metadata for the first region of data has a first defined state if the first region of data is compressed in a first compression process, wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

In Example 43, the subject matter of Examples 36-43 (excluding the present Example) can optionally include wherein the selecting a compression process for compressing the first region of data includes selecting a different compression process for compression of the first region of data which is different from the first compression process, wherein the metadata storing includes updating the metadata for the first region to have a different defined state to indicate the different compression process if the first region of data is compressed in the different compression process.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. A system, comprising:
a central processing unit;
a memory subsystem including a plurality of memories including a first memory having a first region, and a second memory; and
inter-memory transfer interface logic configured to control input/output operations for said memory subsystem wherein the inter-memory transfer interface logic is configured to store in the first region a plurality of units of data, each unit of data including a plurality of subunits of data, including a first subunit of data, said inter-memory transfer interface logic including:
compression/decompression selection logic configured to select a compression process to compress a first plurality of subunits of data of the first region including the first subunit of data;
metadata storage logic configured to store metadata to indicate a compression process selected for the first subunit of data; and
compression logic configured to compress the first plurality of subunits of data of the first region with a selected compression process to provide at least a second subunit of data compressed data so that the second subunit of data encloses in compressed form the data of the first plurality of subunits of data including the first subunit of data; and
wherein the inter-memory transfer interface logic is further configured to transmit a unit of compressed data to the second memory wherein the transmitted unit of compressed data includes multiple subunits of compressed data including said second subunit of data, and to store the unit of compressed data in the second memory.

2. The system of claim 1 wherein each subunit of data has a subunit identification, and the inter-memory transfer interface logic further includes data location identification logic configured to read metadata indicating a compression process selected for the first subunit of data, and identify the second subunit of compressed data stored in the second memory as containing the first subunit of data as a function of the read metadata indicating the compression process selected for the first subunit of data and as a function of a subunit identification of the first subunit of data,
wherein the inter-memory transfer interface logic is further configured to read the second subunit of compressed data from the second memory, and further includes decompression logic configured to receive and decompress the second subunit of compressed data from the second memory as a function of the read metadata indicating the compression process selected for the second subunit data, to restore the first subunit of data of the from the second subunit of compressed data, and
wherein the inter-memory transfer interface logic is further configured to store a restored first subunit of data in the first memory.

3. The system of claim 1 wherein the compression/decompression selection logic is further configured to select a compression process for compression of the first region of data, wherein the metadata storage logic is further configured to store at least one bit of metadata for the first region of data to indicate a compression process selected for the first region of data wherein the metadata for the first region of data has a first defined state if all bits of the first region have a single common state and wherein the inter-memory transfer interface logic is further configured to selectively bypass compression and transmission of the first region of data to the second memory if the metadata for the first region of data has the first defined state, and wherein the metadata for the first region of data has a second, different defined state if bits of the first region have states other than the single common state and wherein the inter-memory transfer interface logic is further configured to transmit data of the first region of data to the second memory if the metadata for the first region of data has the second defined state.

4. The system of claim 3 wherein the metadata storage logic is further configured to store at least two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

5. The system of claim 4 wherein the metadata storage logic is further configured to store at least three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

6. The system of claim 5 wherein the metadata for the first region of data has a sixth defined state if the compression process selected for the first region leaves a second unit of data of the first region as a unit of uncompressed data and compresses a plurality of units of data of the first region into a unit of compressed data.

7. The system of claim 1 wherein the compression/decompression selection logic is further configured to select a compression process to compress the first region of data, wherein the metadata storage logic is further configured to store at least one bit of metadata for the first region of data to indicate a compression process selected for the first region of data wherein the metadata for the first region of data has a first defined state if the first region of data is compressed in a first compression process, and wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

8. The system of claim 7 wherein the compression/decompression selection logic is further configured to select a different compression process for compression of the first region of data which is different from the first compression process, wherein the metadata storage logic is further configured to update the metadata for the first region to have a different defined state to indicate the different compression process if the first region of data is compressed in the different compression process.

9. The system of claim 1 further comprising at least one of:
a display communicatively coupled to the central processing unit, a network interface communicatively coupled to the central processing unit, and a battery coupled to provide power to the system.

10. A method, comprising:
selecting a compression process for selectively compressing a plurality of units of data from a first region of data of a first memory, each unit of data including a plurality of subunits of data;
storing metadata indicating a compression process selected for the first region of data; and
as a function of the selected compression process, selectively:
compressing the plurality of units of data to provide at least a second unit of compressed data including a plurality of subunits of compressed data using a selected compression process so that each subunit of compressed data encloses in compressed form the data of a subunit of the first plurality of units of data;
transmitting the second unit of compressed data to a second memory; and
storing the second unit of compressed data in the second memory.

11. The method of claim 10 wherein each subunit of data of the plurality of units of data has a subunit identification. the method further comprising:
reading metadata indicating a compression process selected for the first region of data;
identifying a location of a subunit of compressed data stored in the second memory as containing a particular subunit of data of the first plurality of units of data as a function of the read metadata indicating the compression process selected for the first region of data and as a function of the subunit identification of the particular subunit of data;
reading and transmitting a located subunit of compressed data from the second memory;
receiving and decompressing the located subunit of compressed data from the second memory, as a function of the read metadata indicating the compression process selected for the region of data, to restore the particular subunit of data from the located subunit of compressed data; and
storing a restored particular subunit of data in the first memory.

12. The method of claim 10 further comprising selecting a compression process for compressing the first region of data, wherein the metadata storing includes storing a bit of metadata for the first region of data to indicate a compression process selected for the first region of data wherein the metadata for the first region of data has a first defined state if all bits of the first region have a single common state and the transmitting and storing are selectively bypassed if the metadata for the first region of data has the first defined state, and wherein the metadata for the first region of data has a second, different defined state if bits of the first region have states other than the single common state and the transmitting is selectively performed if the metadata for the first region of data has the second defined state.

13. The method of claim 12 wherein the metadata storing includes storing two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

14. The method of claim 13 wherein the metadata storing includes storing three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

15. The method of claim 14 wherein the metadata for the first region of data has a sixth defined state if the compression process selected for the first region leaves a second unit of data of the first region as a unit of uncompressed data and compresses a plurality of units of data of the first region into a unit of compressed data.

16. The method of claim 10 further comprising selecting a compression process for compressing the first region of data, wherein the metadata storing includes storing at least one bit of metadata for the first region of data to indicate a compression process selected for the first region of data wherein the metadata for the first region of data has a first defined state if the first region of data is compressed in a first compression process, wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

17. The method of claim 16 wherein the selecting a compression process for compressing the first region of data includes selecting a different compression process for compression of the first region of data which is different from the first compression process, wherein the metadata storing includes updating the metadata for the first region to have a different defined state to indicate the different compression process if the first region of data is compressed in the different compression process.

18. An apparatus for use with a memory subsystem including a plurality of memories including a first memory having a first region, and a second memory, comprising:
inter-memory transfer interface logic configured to control input/output operations for said memory subsystem wherein the inter-memory transfer interface logic is configured to store in the first region a plurality of units of data, each unit of data including a plurality of subunits of data, including a first subunit of data, said inter-memory transfer interface logic including:
compression/decompression selection logic configured to select a compression process to compress a first plurality of subunits of data of the first region including the first subunit of data;
metadata storage logic configured to store metadata to indicate a compression process selected for the first subunit of data; and
compression logic configured to compress the first plurality of subunits of data of the first region with a selected compression process to provide at least a second subunit of data compressed data so that the second subunit of data encloses in compressed form the data of the first plurality of subunits of data including the first subunit of data; and
wherein the inter-memory transfer interface logic is further configured to transmit a unit of compressed data to the second memory wherein the transmitted unit of compressed data includes multiple subunits of compressed data including said second subunit of data, and to store the unit of compressed data in the second memory.

19. The apparatus of claim 18 wherein each subunit of data has a subunit identification, and the inter-memory transfer interface logic further includes data location identification logic configured to read metadata indicating a compression process selected for the first subunit of data, and identify the second subunit of compressed data stored in the second memory as containing the first subunit of data as a function of the read metadata indicating the compression process selected for the first subunit of data and as a function of a subunit identification of the first subunit of data,
wherein the inter-memory transfer interface logic is further configured to read the second subunit of compressed data from the second memory, and further includes decompression logic configured to receive and decompress the second subunit of compressed data from the second memory as a function of the read metadata indicating the compression process selected for the second subunit data, to restore the first subunit of data of the from the second subunit of compressed data, and
wherein the inter-memory transfer interface logic is further configured to store a restored first subunit of data in the first memory.

20. The apparatus of claim 18 wherein the compression/decompression selection logic is further configured to select a compression process for compression of the first region of data, wherein the metadata storage logic is further configured to store at least one bit of metadata for the first region of data to indicate a compression process selected for the first region of data wherein the metadata for the first region of data has a first defined state if all bits of the first region have a single common state and wherein the inter-memory transfer interface logic is further configured to selectively bypass compression and transmission of the first region of data to the second memory if the metadata for the first region of data has the first defined state, and wherein the metadata for the first region of data has a second, different defined state if bits of the first region have states other than the single common state and wherein the inter-memory transfer interface logic is further configured to transmit data of the first region of data to the second memory if the metadata for the first region of data has the second defined state.

21. The apparatus of claim 20 wherein the metadata storage logic is further configured to store at least two bits of metadata for the first region of data to indicate a compression process selected for the first region of data wherein the metadata for the first region of data has a third defined state if the compression process selected for the first region compresses all units of data of the first region into a single unit of compressed data, and has a fourth defined state if the compression process selected for the first region compresses a first plurality of units of data of the first region into a first unit of compressed data and compresses a second plurality of units of data of the first region into a second unit of compressed data.

22. The apparatus of claim 21 wherein the metadata storage logic is further configured to store at least three bits of metadata for the first region of data to indicate a compression process selected for the first region of data wherein the metadata for the first region of data has a fifth defined state if the compression process selected for the first region compresses a plurality of units of data of the first region into a unit of compressed data and leaves a first unit of data of the first region as a unit of uncompressed data.

23. The apparatus of claim 22 wherein the metadata for the first region of data has a sixth defined state if the compression process selected for the first region leaves a second unit of data of the first region as a unit of uncompressed data and compresses a plurality of units of data of the first region into a unit of compressed data.

24. The apparatus of claim 18 wherein the compression/decompression selection logic is further configured to select a compression process to compress the first region of data, wherein the metadata storage logic is further configured to store at least one bit of metadata for the first region of data to indicate a compression process selected for the first region of data wherein the metadata for the first region of data has a first defined state if the first region of data is compressed in a first compression process, and wherein the metadata for the first region of data has a second defined state if the first region of data is compressed in a second compression process, and wherein the metadata for the first region of data has an nth defined state if the first region of data is compressed in an nth compression process wherein the number of bits of metadata is greater than one if n is greater than two.

25. The apparatus of claim 24 wherein the compression/decompression selection logic is further configured to select a different compression process for compression of the first region of data which is different from the first compression process, wherein the metadata storage logic is further configured to update the metadata for the first region to have a different defined state to indicate the different compression process if the first region of data is compressed in the different compression process.
